(19) United States
(12) Patent Application Publication
(10) Pub. No.: US 2025/0354914 A1
(43) Pub. Date: Nov. 20, 2025

(54) METHOD AND APPARATUS FOR ANALYZING OBJECTS WITH A COHERENT OPTICAL SYSTEM

(71) Applicant: CIENA CORPORATION, Hanover, MD (US)

(72) Inventors: Brandon Taylor Buscaino, Mountain View, CA (US); Seyed Parsa Mirdehghan, Richmond Hill (CA); Mohammad Ebrahim Mousa Pasandi, Ottawa (CA); Douglas Charlton, Kanata (CA); Kiriakos Neoklis Kutulakos, Toronto (CA); David Brian Lindell, Toronto (CA)

(73) Assignee: CIENA CORPORATION, Hanover, MD (US)

(21) Appl. No.: 19/089,335

(22) Filed: Mar. 25, 2025

Related U.S. Application Data
(60) Provisional application No. 63/648,779, filed on May 17, 2024.

(51) Int. Cl. G01N 21/21; G01N 21/17; G01S 17/894

(52) U.S. Cl. CPC G01N 21/211; G01S 17/894; G01N 2021/1772; G01N 2201/06113; G01N 2201/0691

(57) ABSTRACT

Aspects of the subject disclosure may include, for example, a method, apparatus and computer readable media for analyzing objects using a coherent optical system. This innovative approach leverages dual-polarization coherent modulation to generate optical signals encoded with digital information across multiple dimensions, such as amplitude, phase, and polarization. These signals are transmitted to a target scene resulting in reflected signals that are received and processed to detect and identify objects based on a comparison with the original transmitted signals. These techniques offer significant improvements in accuracy and robustness, overcoming limitations of traditional lidar and depth camera systems, particularly in dynamic or complex environments. The disclosed technology is applicable across various industries, including autonomous vehicles and environmental monitoring, providing enhanced precision in distance, velocity, and polarization measurements. Other embodiments are disclosed.

### CROSS REFERENCE TO RELATED APPLICATIONS

The present application claims the benefit of priority to U.S. Provisional Application No. 63/648,779 filed on May 17, 2024, which is hereby incorporated herein by reference in its entirety.

### FIELD OF THE DISCLOSURE

The subject disclosure relates to a method and apparatus for analyzing objects with a coherent optical system.

### BACKGROUND

In recent years, the demand for advanced optical systems capable of precise object analysis has significantly increased, driven by rapid advancements in digital technology and telecommunications. Among these systems, lidar and depth cameras have emerged as pivotal technologies for capturing detailed three-dimensional information about environments.

Lidar, which stands for Light Detection and Ranging, is a remote sensing technology that uses laser light to measure distances and create high-resolution spatial maps. It operates by emitting laser pulses towards a target and measuring the time it takes for the reflected light to return, allowing for precise distance calculations. Traditional lidar systems are categorized into incoherent and coherent types. Incoherent lidar systems rely on intensity modulation to recover scene geometry, measuring phase delays or propagation delays of laser pulses. However, they are often sensitive to interference from ambient light, such as sunlight or other lidar systems, which can degrade their performance. Coherent lidar systems, on the other hand, detect the amplitude and phase of backscattered light by interfering it with a reference beam, offering improved signal-to-noise ratio and robustness to ambient light interference. Despite these advancements, traditional lidar systems face challenges in achieving high accuracy and reliability, particularly in dynamic or complex environments.

Depth cameras represent another critical technology that captures three-dimensional information by measuring a distance of objects from the camera. They operate using various technologies, such as structured light, time-of-flight, or stereo vision. Structured light systems project a known pattern onto a scene and analyze its deformation to calculate depth information. Time-of-flight cameras emit light pulses and measure the return time after reflection, similar to lidar, allowing for precise distance calculations. Stereo vision systems use multiple cameras to capture images from different perspectives, using the disparity to infer depth. While depth cameras offer significant advantages in capturing 3D data, they also face limitations. Structured light systems can be affected by ambient light, time-of-flight cameras may suffer from multipath interference, and stereo vision systems can struggle with textureless surfaces or low-light conditions.

As the need for more robust and versatile optical systems grows, there is a pressing requirement for innovative solutions that can overcome these limitations, providing enhanced accuracy, speed, and reliability in object analysis. The ongoing evolution of lidar and depth camera technologies is crucial for enabling new applications and enhancing existing systems across various industries, from autonomous vehicles to environmental monitoring and beyond.

### BRIEF DESCRIPTION OF THE DRAWINGS

Reference will now be made to the accompanying drawings, which are not necessarily drawn to scale, and wherein:

FIG. 1A is a block diagram illustrating an example, non-limiting embodiment of full-wavefield lidar system in accordance with various aspects described herein.

FIG. 1B is a photographic image of an example scene evaluated by a full-wave lidar system, such as the example full-wave lidar system of FIG. 1A.

FIG. 1C is an example of processed results obtained from illumination of the example scene illustrated in FIG. 1B and evaluated by a full-wave lidar system, such as the example full-wave lidar system of FIG. 1A.

FIG. 2A is a photographic image of an example scene for evaluation by an example, non-limiting embodiment of a full-wave lidar system, in accordance with various aspects described herein.

FIG. 2B is a graphical image illustrating an example of processed results of the example scene presented in FIG. 2A by a commercially available 3D depth sensor.

FIG. 2C is a graphical image illustrating an example, non-limiting embodiment of processed results of the example scene presented in FIG. 2A by the full-wave lidar system of FIG. 1A, in accordance with various aspects described herein.

FIG. 2D is a graphical image illustrating an example, non-limiting embodiment of other processed results of the image presented in FIG. 2A by a single-photon lidar system, in accordance with various aspects described herein.

FIG. 3A is a block diagram illustrating an example, non-limiting embodiment of an incoherent detection system in accordance with various aspects described herein.

FIG. 3B is a block diagram illustrating an example, non-limiting embodiment of a coherent detection system in accordance with various aspects described herein.

FIG. 4A is an example, non-limiting embodiment of data collection resulting in an example segment of data in accordance with various aspects described herein

FIG. 4B is a schematic diagram illustrating an example, non-limiting embodiment of encoded data corresponding to the example segment of data of FIG. 4A in accordance with various aspects described herein.

FIG. 4C is a modulation graph illustrating an example, non-limiting embodiment of a modulation signal that may result from an application of the encoded data of FIG. 4B to a physical signal, in accordance with various aspects described herein.

FIG. 4D is a demodulation graph illustrating an example, non-limiting embodiment of demodulation of a received waveform corresponding to the modulation graph of FIG. 4C.

FIG. 5 provides an overview of scenic analyzer system that utilizes an optical modem to simultaneously measure scenic properties that may include one or more of distance, axial velocity, and/or polarization.

FIG. 6 is a block diagram illustrating an example, non-limiting embodiment of a scenic analyzer system, in accordance with the various aspects described herein.

FIG. 7 presents graphs illustrating an example, non-limiting embodiment of an application of estimated Jones matrices.

FIG. 8A is a photograph illustrating an example, non-limiting embodiment of a hardware prototype of an image scanning system, in accordance with various aspects described herein.

FIG. 8B is a block diagram illustrating an example, non-limiting embodiment of a scanning system, such as the hardware prototype scanning system of FIG. 8A, in accordance with various aspects described herein.

FIG. 9 illustrates photographic images of example scenes for evaluation by various scanning systems including a full-wave lidar system, in accordance with various aspects described herein.

FIG. 10A is a photographic image of an example scene for evaluation by the example techniques disclosed herein, in accordance with various aspects described herein.

FIG. 10B presents graphical images illustrating example, non-limiting embodiments of processed results of the example scene presented in FIG. 10A using a matched filter and obtained at various exposure settings, in accordance with various aspects described herein.

FIG. 10C presents graphical images illustrating example, non-limiting embodiments of processed results example scene presented in FIG. 10A, optimized and obtained at various exposure settings, in accordance with various aspects described herein.

FIG. 11A presents a photographic image of a scene including a diffuse statuette and mask made from translucent material and results obtained therefrom.

FIG. 11B presents a photographic image of a scene of a larger room size and results obtained therefrom.

FIG. 11C shows a photograph an example scene in which a statuette is placed behind a translucent surface and results obtained therefrom.

FIG. 11D shows a photograph an example scene in which the image is obtained under strong ambient light and results obtained therefrom.

FIG. 11E shows a photograph another example complex scene and results obtained therefrom.

FIG. 12A is a block diagram illustrating an example, non-limiting embodiment of a transmit and receive path of a coherent optical modem, in accordance with the various aspects described herein.

FIG. 12B is a block diagram illustrating an example, non-limiting embodiment of an optical modem receiver that may be included in the example coherent optical modem of FIG. 12A, in accordance with the various aspects described herein.

FIG. 12C is a photograph illustrating an example, non-limiting embodiment of a coherent optical modem, in accordance with the various aspects described herein.

FIG. 13 is a photograph of an example, non-limiting embodiment of a single photon lidar system in accordance with various aspects described herein.

FIG. 14 illustrates graphical results obtained for a sample image using the various approaches disclosed herein, in accordance with the various aspects disclosed herein.

FIG. 15A photographic image of an example scene for evaluation by imaging systems, in accordance with various aspects described herein.

FIG. 15B illustrates graphical results obtained for the scene of FIG. 15A using the various approaches disclosed herein, in accordance with the various aspects disclosed herein.

FIG. 16A is a photograph illustrating an experimental setup for assessing radial velocity predictions from a coherent optical modem in accordance with various aspects described herein.

FIG. 16B is a series of high-speed photographs illustrating rotation of a rotating disk of the experimental setup depicted in FIG. 16A in accordance with various aspects described herein.

FIG. 16C is a graphical diagram illustrating an example, non-limiting embodiment of experimental results for assessing radial velocity predictions for the rotating disk of the experimental setup of FIGS. 16A and 16B using a coherent optical modem in accordance with various aspects described herein.

FIG. 17A is a photograph illustrating an experimental setup for assessing performance of a coherent optical modem in accordance with various aspects described herein.

FIG. 17B is a graphical diagram illustrating an example, non-limiting embodiment of experimental results for assessing performance of a coherent optical modem in evaluating the scene depicted in FIG. 17A accordance with various aspects described herein.

FIG. 18A depicts an illustrative embodiment of a process for analyzing objects using a coherent optical system, in accordance with various aspects described herein.

FIG. 18B depicts an illustrative embodiment of another process for analyzing objects using a coherent optical system, in accordance with various aspects described herein.

FIG. 18C depicts an illustrative embodiment of yet another process for analyzing objects using a coherent optical system, in accordance with various aspects described herein.

FIG. 19 is a block diagram of an example, non-limiting embodiment of a computing environment in accordance with various aspects described herein.

### DETAILED DESCRIPTION

The subject disclosure describes, among other things, illustrative embodiments for utilizing multi-polarization coherent modulation to generate and process optical signals for enhancing detection and identification of objects in complex environments. Other embodiments are described in the subject disclosure.

One or more aspects of the subject disclosure include a process that includes generating a first optical signal from a dual-polarization coherent modulator, wherein the dual-polarization coherent modulator receives a first electrical signal and optical signals generated by an optical source, wherein the first electrical signal includes digital information encoded across multiple dimensions of the first optical signal. The process further incudes transmitting the first optical signal to a target scene including objects and receiving a second optical signal from the target scene, wherein the second optical signal corresponds to a reflection of the first optical signal from the objects of the target scene. According to the process, the second optical signal is converted in a dual-polarization coherent receiver to generate a second electrical signal and the second electrical signal is processed to detect and identify the objects in the target scene based on a comparison of the second electrical signal to the first electrical signal. The comparison identifies second portions of the second electrical signal that resemble either completely or partially the digital information encoded across the multiple dimensions of the first optical signal.

In another embodiment, the disclosure includes a process wherein the objects in the target scene are characterized by variables utilized in the comparison, the variables include distance, relative velocity, intensity, polarization, orientation, or combinations thereof; wherein the processing of the second electrical signal characterizes the variables singly or in any combination.

In some embodiments, the optical source includes one or more narrow-linewidth continuous-wave lasers.

In some embodiments, the multiple dimensions of the first optical signal include amplitude, phase, polarization, or any combination thereof, and wherein the digital information encoded across the multiple dimensions of the first optical signal is mutually correlated or uncorrelated.

In some embodiments, the digital information encoded across multiple dimensions of the first optical signal includes pseudo-random data selected from a class of orthogonal sequences.

In some embodiments, the second optical signal is received via a lens that is used for transmitting the first optical signal.

In some embodiments, the second optical signal is received via a first lens that differs from a second lens used for transmitting the first optical signal; wherein the second optical signal is related to the first optical signal via reflection, refraction, diffusion, scattering, or combinations thereof.

In some embodiments, the processing the second electrical signal is performed by a cross-correlation of the second portions of the second electrical signal with first portions of the first electrical signal.

In some embodiments, the second portions of the second electrical signal are identified based on a second phase of the second optical signal, a second amplitude of the second optical signal, a second polarization of the second optical signal, or combinations thereof compared to a first phase of the first optical signal, a first amplitude of the first optical signal, a first polarization of the first optical signal, or combinations thereof.

In yet another embodiment, the disclosure includes a process wherein the comparison of the second electrical signal to the first electrical signal is based on a model of the second optical signal that includes phase, amplitude, polarization, or combinations thereof, and wherein variables of the model include time, velocity, position, orientation, or combinations thereof.

The comparison of the second electrical signal to the first electrical signal is performed using a gradient descent algorithm.

In at least some embodiments, comparison of the second electrical signal to the first electrical signal limits a search space of the variables to increase efficiency of the comparison.

In at least some embodiments, the comparison of the second electrical to the first electrical signal is performed via time gating, polarization gating, angular gating, doppler gating, or combinations thereof.

In at least some embodiments, the comparison of the second electrical signal to the first electrical signal uses prior knowledge of the target scene, and wherein this prior knowledge is used for calibration of the comparison.

In at least some embodiments, identification of static objects in the target scene, rejection of noise, or combinations thereof; wherein the comparison of the second electrical signal to the first electrical signal includes one or more processing stages, and wherein the one or more processing stages has a same, similar or different accuracy in detecting or identifying of the objects.

In at least some embodiments, the comparison of the second electrical signal to the first electrical signal utilizes a variation penalty across the target scene to detect or identify the objects; wherein the comparison of the second electrical signal to the first electrical signal utilizes sparsity of the target scene to detect or identify the objects.

In at least some embodiments, the comparison of the second electrical signal to the first electrical signal utilizes regularizers, and wherein the regularizers include L1 norm, Frobenius norm, determinant, unitary constraints, or combinations thereof of the model of the second optical signal, and wherein the regularizers are related to a signal-to-noise ratio of the second electrical signal, and wherein the regularizers are applied to a portion of the second electrical signal, and wherein the regularizers are chosen to be robust to noise.

In at least some embodiments, the processing includes up-sampling or down-sampling of the first electrical signal, the second electrical signal, or combinations thereof.

One or more aspects of the subject disclosure include a device including a processing system having a processor and a memory. The memory stores executable instructions that, when executed by a processing system including a processor, facilitate performance of operations. The operations include generating a first optical signal from a dual-polarization coherent modulator, wherein the dual-polarization coherent modulator receives a first electrical signal and optical signals generated by an optical source, wherein the first electrical signal includes digital information encoded across multiple dimensions of the first optical signal; transmitting the first optical signal to a target including objects. The operations further include receiving a second optical signal reflected from the objects of the target and converting the second optical signal in a dual-polarization coherent receiver to generate a second electrical signal. The operations further include identifying the objects in the target by comparing second portions of the second electrical signal that resemble entirely or partially the digital information encoded across the multiple dimensions of the first optical signal.

One or more aspects of the subject disclosure include a non-transitory, machine-readable medium that includes executable instructions that, when executed by a processing system including a processor, facilitate performance of operations. The operations include generating a first optical signal from a coherent modulator, wherein the coherent modulator receives a first electrical signal that includes digital information encoded across multiple dimensions of the first optical signal and transmitting the first optical signal to objects. The operations further include receiving a second optical signal that corresponds to a reflection of the first optical signal from the objects and converting the second optical signal in a coherent receiver to generate a second electrical signal. The operations further include identifying the objects by comparing second portions of the second electrical signal that resemble at least in part the digital information encoded across the multiple dimensions of the first optical signal, wherein the coherent modulator corresponds to a dual-polarization coherent modulator, and wherein the coherent receiver corresponds to a dual-polarization coherent receiver. These and other features will be more clearly understood from the following detailed description taken in conjunction with the accompanying drawings and claims.

The advent of the digital age has driven the development of coherent optical modems-devices that modulate the amplitude and phase of light in multiple polarization states. These modems transmit data through fiber optic cables that are thousands of kilometers in length at data rates exceeding one terabit per second. This remarkable technology is made possible through near-THz-rate programmable control and sensing of the full optical wavefield. While coherent optical modems form the backbone of telecommunications networks around the world, their extraordinary capabilities also provide unique opportunities for imaging. The embodiments disclosed herein encompass full-wavefield lidar: a new imaging modality that repurposes off-the-shelf coherent optical modems to simultaneously measure scenic properties, e.g., including one or more of distance, axial velocity, and/or polarization. This modality can be demonstrated by combining a 74 GHz-bandwidth coherent optical modem with free-space coupling optics and scanning mirrors. The disclosed embodiments further encompass a time-resolved image formation model for such systems, including formulation of maximum-likelihood reconstruction algorithms to recover one or more of depth, velocity, and/or polarization information at each scene point from the modem's raw transmitted and received symbols. Compared to existing lidars, full-wavefield lidar promises improved mm-scale ranging accuracy from brief, microsecond exposure times, reliable velocimetry, and robustness to interference from ambient light or other lidar signals.

Coherent optical modems are conventionally used to send digital signals over fiber optic cables by modulating the phase and amplitude of coherent light. Driven by the ever-increasing demands for higher networking bandwidths, these modems can now modulate and sample light at staggering rates-up to 100 GHz-across two orthogonal linear polarizations simultaneously. In effect, modern coherent optical modems achieve near-THz-rate, programmable control and sensing of the full optical wavefield, with a reliability that already supports communication over optical fibers spanning thousands of kilometers.

The extreme abilities of these devices to manipulate and sense light within a fiber raise a question addressed by this disclosure: how can off-the-shelf optical modems be leveraged to advance the state of the art in free-space imaging? As a first step toward addressing this question, a full-wavefield lidar (FWL) was introduced, providing a new lidar sensing modality for simultaneous measurement of one or more of a distance, an axial velocity, and/or two orthogonal linear polarization states using coherent optical modems. To realize FWL, and by way of nonlimiting example, free-space coupling optics and a conventional galvanometer can be used to turn a 400 Gb/s off-the-shelf coherent optical modem into a coherent lidar system that raster-scans the field of view.

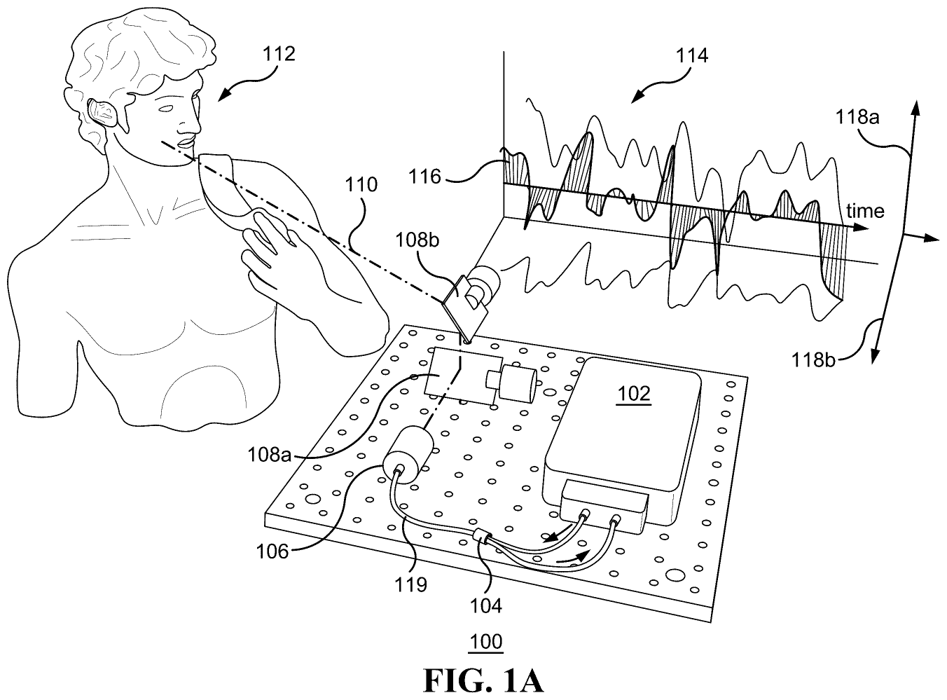

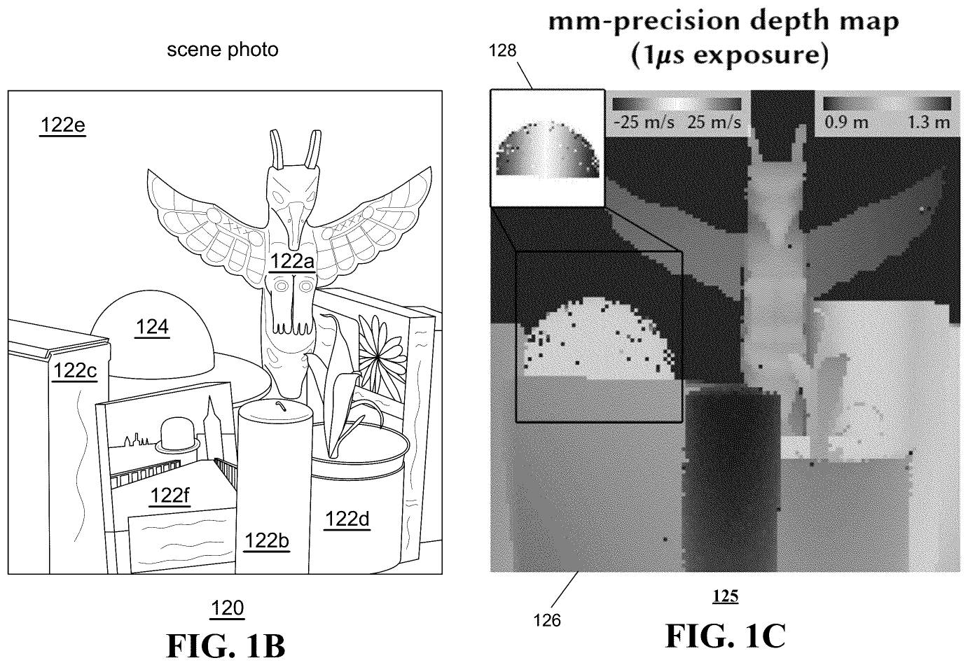

FIG. 1A is a block diagram illustrating an example, non-limiting embodiment of full-wavefield lidar system 100 in accordance with various aspects described herein. The example full-wave lidar system 100 includes a coherent optical modem 102, a circulator 104, a free-space coupler, in this example, a collimator 106, and one or more reflective surfaces. According to the illustrative example, the reflective surfaces include a first scanning mirror 108a and a second scanning mirror 108b. It is envisioned that in at least some embodiments, one or more of the first and second scanning mirrors 108a, 108b, generally 108, can be controlled, e.g., servo-controlled, to impart a variable directivity to an optical beam 110 provided by the coherent optical modem 102. For example, in at least some embodiments, the first and second scanning mirrors 108 can be configured to perform a controlled scanning of a scene 112 according to a rasterized scanning pattern.

Also shown along with the example full-wave lidar system 100, is a sample time segment of an electric field corresponding to an example laser modulation 114 as may be applied to the optical beam 110 by the coherent optical modem 102. In more detail, the sample time segment of the electric field amplitude 116 includes a perspective view of the modulated optical beam 110 along with corresponding polarizations, e.g., a first polarization 118a and a second polarization 118b, which can include orthogonal polarizations.

The illustrative embodiment of the full-wavefield lidar system 100 repurposes an off-the-shelf coherent optical modem 102—typically used for telecommunications—for coherent lidar. The modem 102 modulates the amplitude and phase of light from a 1550 nm laser in two linear polarization states. The light is emitted through one or more of a fiber optic cable 119, free-space collimator 106, and scanning mirrors 108, and illuminates a target 112. The reflected light is coupled into the fiber 119 and directed to a receiver through the circulator 104. The modem 102, in this example configuration, uses homodyne interferometry to measure the amplitude and phase of light in orthogonal polarization states.

FIG. 1B is a photographic image of an example scene 120 evaluated by a full-wave lidar system, such as the example full-wave lidar system 100 of FIG. 1A. The scene 120 includes various static scenic elements, such as an example figurine 122a, a candle 122b, a portion of a box 122c, a container 122d, a book 122f and a background scenic element 122e, e.g., a screen or a wall. The example scene 120 further includes at least one dynamic scenic element, in this instance, including a dynamic scenic element in the form of a spinning hemisphere 124.

FIG. 1C is an example of processed results 125 obtained from illumination of the example scene 120 illustrated in FIG. 1B and evaluated by a full-wave lidar system, such as the example full-wave lidar system 100 of FIG. 1A. The example processed results 125 include a depth map 126 representing distances or depths from the example lidar source, e.g., the modem 102 to the various scenic elements, including the static scenic elements 122a, 122b, 122c, 122d, 122e, 122f, generally 122, and the spinning hemisphere 124 illuminated by the full-wave lidar system 100. The processed results 125 also include an example velocity map 128 representing velocities of at least the spinning hemisphere 124 illuminated in the example scene 120.

Based on these measurements, a joint estimation of a mm-scale 3D geometry and velocity of dynamic objects, e.g., the spinning hemisphere 124, captured within example scene 120 with just 1 μs per-pixel exposure time and an eye-safe transmit power of 10 mW. The example depth and velocity maps 126, 128 are acquired with 2 mm and 0.9 m/s resolution.

According to the illustrative example, a time-resolved image formation model can be developed that captures one or more properties of the raw output of optical modems, e.g., the example modem 102, repurposed for free-space imaging—including internal reflections, Doppler shifts, and the scrambled polarization state of back-scattered light—and use this model to formulate a maximum-likelihood reconstruction algorithm. In at least some embodiments, one or more of these properties may differ from modem to modem, and in at least that sense, be unique. By way of example, a processing algorithm can rely on the modem's raw output to solve an inverse problem that jointly recovers one or more of depth, velocity, and/or polarization information.

Compared to existing lidars, FWL offers significantly more flexibility and control over the transmitted waveforms of light; mm-scale ranging; reliable velocimetry; improved performance at very short (e.g., microsecond) exposure times with eye-safe transmit power; and robustness to interference from ambient light or other lidar signals. The various examples disclosed herein demonstrate how a full-wavefield lidar system can be configured to capture a variety of challenging scenes, including scenes with one or more of moving objects, partial transparencies, strong ambient light, and/or specular surfaces.

The example devices, systems and processes disclosed herein include multiple types of lidar and other sensing modalities. An overview of connections to incoherent lidar systems, coherent lidar systems, and to optical telecommunications technologies follows.

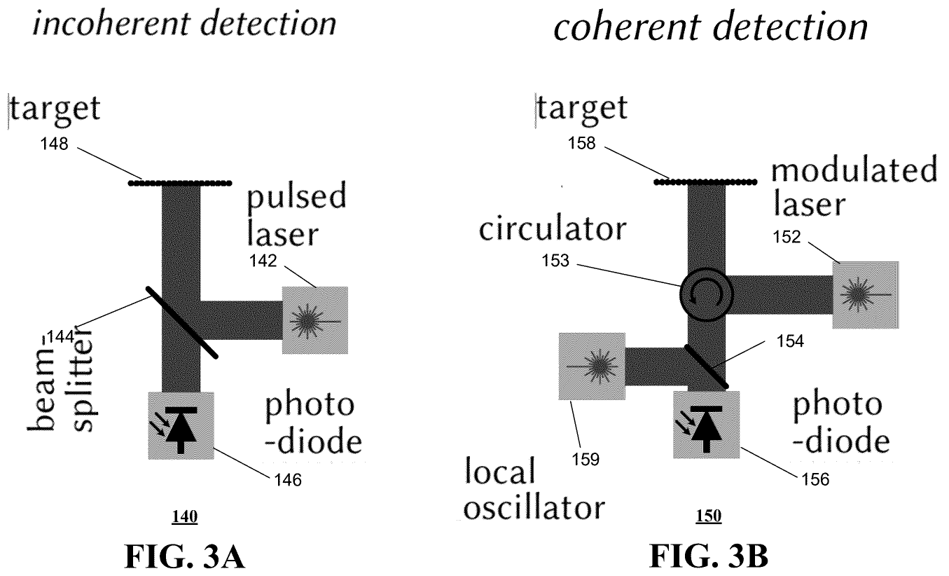

Incoherent Lidar. FIG. 3A is a block diagram illustrating an example, non-limiting embodiment of an incoherent detection system 140 in accordance with various aspects described herein. The incoherent detection system 140 includes a pulsed laser 142, a beam splitter 144 and a photodiode 146. The pulsed laser 142 is configured to direct a pulsed optical beam towards the beam splitter 144, which is configured to direct at least a portion of the pulsed optical beam towards a target 148. The target 148 reflects and/or otherwise scatters at the pulsed optical beam, at least a portion of which is directed towards the beam splitter 144. The beam splitter 154, in turn, allows at least a portion of the reflected/scattered optical beam to pass through towards the photodiode 146.

Most commercial lidar systems operate on a principle of incoherent detection. These lidars modulate the intensity of light to recover scene geometry by measuring phase delays of a sinusoidally modulated signal or propagation delays of emitted and backscattered laser pulses. Incoherent lidars can also capture polarization information of backscattered light. However, incoherent detection schemes are sensitive to interference from other light sources or ambient light (e.g., from other lidars or the sun). While incoherent continuous wave systems can measure velocity from phase shifts due to the Doppler effect, pulsed systems are not sensitive to phase information and cannot be used for velocimetry in the same fashion. FWL recovers accurate depth with 1 μs exposure times that are 10,000× shorter than that of incoherent, intensity-modulated depth sensors.

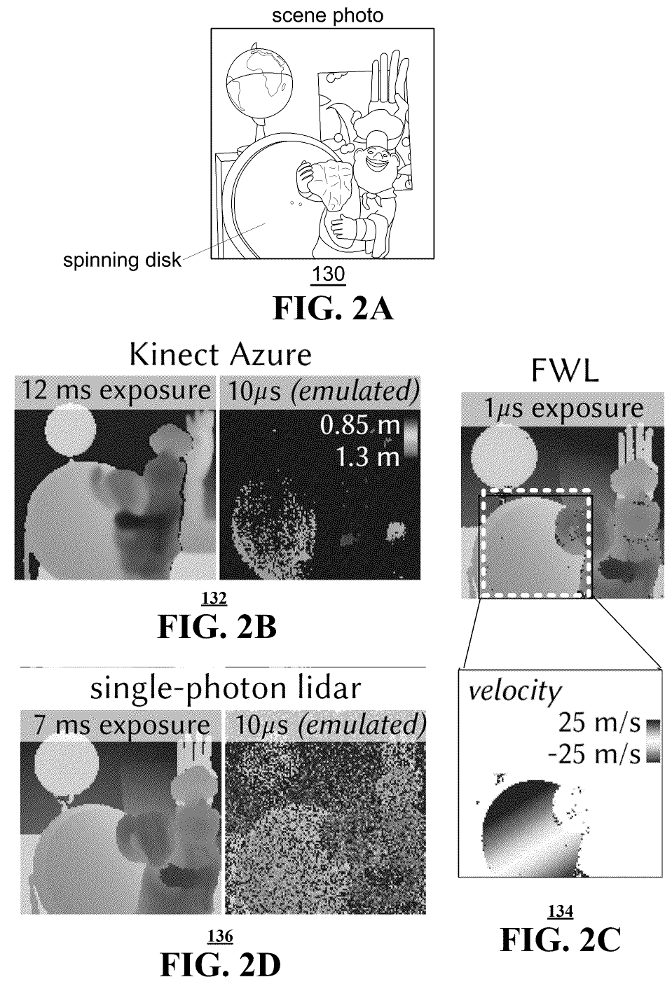

FIG. 2A is a photographic image of an example scene 130 for evaluation by an example, non-limiting embodiment of a full-wave lidar system, in accordance with various aspects described herein. The scene 130 includes multiple static scenic elements of various sizes, shapes, colors, shadings, depths and complexities. The scene 130 also includes one dynamic element, e.g., a rotating disk, positioned amidst the static scenic elements.

FIG. 2B is a graphical image illustrating an example of processed results 132 of the example scene 130 presented in FIG. 2A by a commercially available 3D depth sensor (e.g., the Kinect® Azure 3D depth sensor, which uses ˜10 ms exposure times), obtained from Microsoft Corp., Washington. The processed results 132 demonstrate a reasonable representation of the depths to the various scene points of the example scene 130 obtained with a 12 ms exposure. The processed results 132 include emulated results representing a 10 μsec exposure. Details of the example scene 130 are barely to non-perceptible at the shorter exposure interval.

FIG. 2C is a graphical image illustrating an example, non-limiting embodiment of processed results 134 of the example scene 130 presented in FIG. 2A by the full-wave lidar system 100 of FIG. 1A, in accordance with various aspects described herein. The processed results 134 demonstrate ranging and velocimetry information providing. The ranging information provides an accurate representation of the depths to the various scene points the example scene 130 obtained with only a 1 μsec exposure. The velocimetry information is provided as a drawing inset related to the dynamic scenic element, i.e., the rotating disk. The velocimetry information includes magnitude and direction information according to a shading and/or color scale presented in the inset.

Single-photon lidar. Incoherent lidars based on single-photon detection are notable for their extreme sensitivity to individual particles of light. However, the advantages of single-photon lidar are primarily in the weak signal regime where photons arrive infrequently at rates that are much lower than the detector dead time, which is typically on the order of tens of nanoseconds. At higher signal levels, photon arrivals are missed, leading to difficult-to-model, non-linear distortions in photon arrival times that skew ranging estimates.

FIG. 2D is a graphical image illustrating an example, non-limiting embodiment of other processed results 136 of the image presented in FIG. 2A by a single-photon lidar system, in accordance with various aspects described herein. The processed results 136 demonstrate an accurate representation of the depths to the various scene points the example scene 130 obtained with a 7 msec exposure. The processed results 134 also demonstrate an example representation of the depths to the various scene points the example scene 130 obtained with only an emulated 10 usec exposure. Although the image lacks clarity of the longer exposure, significant information related to depths to the various scene points the example scene 130 are perceptible.

The example devices systems and processes disclosed herein can function robustly with relatively short exposure times, e.g., having exposures of 1 μs or less. It should be appreciated that at such short exposure times, a typical single photon lidar in the linear, low-flux regime might detect less than one laser photon on average. Further, any received photons could be obscured by detections from ambient light. This makes single-photon lidar very challenging when dealing with very short exposure times and ambient light.

2.2 Coherent Lidar. FIG. 3B is a block diagram illustrating an example, non-limiting embodiment of a coherent detection system 150 in accordance with various aspects described herein. The coherent detection system 150 includes a modulated laser 152, a circulator 153, a beam splitter 154 and a photodiode 156. The modulated laser 152 is configured to direct a modulated optical beam towards circulator 153, which is configured to direct at least a portion of the modulated optical beam towards a target 158. The target 158, in turn, reflects and/or otherwise scatters the modulated optical beam, at least a portion of which is directed towards the circulator 153. The circulator 153, in turn, is configured to direct at least a portion of the reflected/scattered optical beam towards the beam splitter 154. The beam splitter 154 allows at least a portion of the reflected/scattered optical beam to pass through to the photodiode 156. The coherent detection system 150 also includes at least one local oscillator 159. The local oscillator 159 is configured to direct a reference optical beam towards the beam splitter 154, which is configured to direct at least a portion of the reference optical beam towards the photodiode 156.

Coherent lidar detects the amplitude and/or phase of backscattered incident laser light by interfering it with unmodulated light from the same laser (referred to as the local oscillator), or from another laser at a different frequency. In contrast to incoherent lidar or other techniques such as optical coherence tomography, it is important that in at least some embodiments the laser source have a relatively high degree of temporal coherence so that the incident light and local oscillator remain correlated when they are interfered at a photodiode, as illustrated in FIG. 3B. A mathematical description of coherent detection is provided hereinbelow.

In general, coherent lidar systems have several advantages compared to their incoherent counterparts. Since they use continuous wave emission, they can allow eye-safe operation at higher average optical powers compared to pulsed lasers, which may have very high peak power depending on the duty cycle. Additionally, their use of coherent averaging (i.e., of the complex electric field) results in a linear increase in signal-to-noise ratio (SNR) with exposure time compared to the square-root relation of incoherent averaging of intensity measurements. Further, coherent detection strongly suppresses interference from ambient light due to the interferometric detection procedure and use of balanced photodetectors.

FMCW lidar. Perhaps the most common type of coherent lidar is based on a frequency-modulated continuous wave (FMCW) transmit signal. Specifically, FMCW lidars transmit a “chirp” signal whose optical frequency increases linearly with time. The depth resolution is tied to the frequency tuning range of the laser source, and the maximum range depends on the coherence length of the laser. Still, FMCW lidars are sensitive to interference from other frequency-modulated lidars and require transmitting multiple chirps to unambiguously resolve range and velocity.

RMCW lidar. Many of the drawbacks associated with FMCW lidar are mitigated with random modulation continuous wave (RMCW) lidar. This modality uses a random phase and amplitude encoding that suppresses interference and enables unambiguous ranging and velocimetry. However, there are considerable implementation challenges. The range resolution is determined, in part, by the modulation speed and sample rate-typically tens of GHz to achieve mm-scale resolution. Thus, few examples of this modality exist in the literature due to the significant hardware requirements related to ultrafast sample rates and the computational challenge of modeling Doppler shifts, laser phase noise, speckle, and polarization changes induced by scattering.

The example embodiments disclosed herein overcomes hardware challenges associated with RMCW lidar by leveraging existing, off-the-shelf optical modems used for telecommunications. The disclosed embodiments demonstrate that FWL improves the accuracy of ranging and velocimetry over other modulation schemes (e.g., without phase modulation or amplitude modulation) implemented on the same optical modem. It has been recognized that in at least some embodiments, a polarization-aware reconstruction framework improves accuracy and performance at low SNRs compared to matched-filtering schemes similar to those used in RMCW lidar.

Optical Telecommunications. At least some of the example systems, devices and processes disclosed herein make use of coherent optical modems that are conventionally used to send digital signals over fiber optic cables. Typically, these modems use a modulation scheme to optically encode digital information in the amplitude, phase, polarization, and frequency of transmitted light. Signals from optical modems are often combined with wavelength division multiplexing and transmitted in parallel across a single-mode fiber at different wavelengths (e.g., 1530-1565 nm). Polarization division multiplexing is also used to transmit two signals in parallel using orthogonal linear polarizations of the electric field.

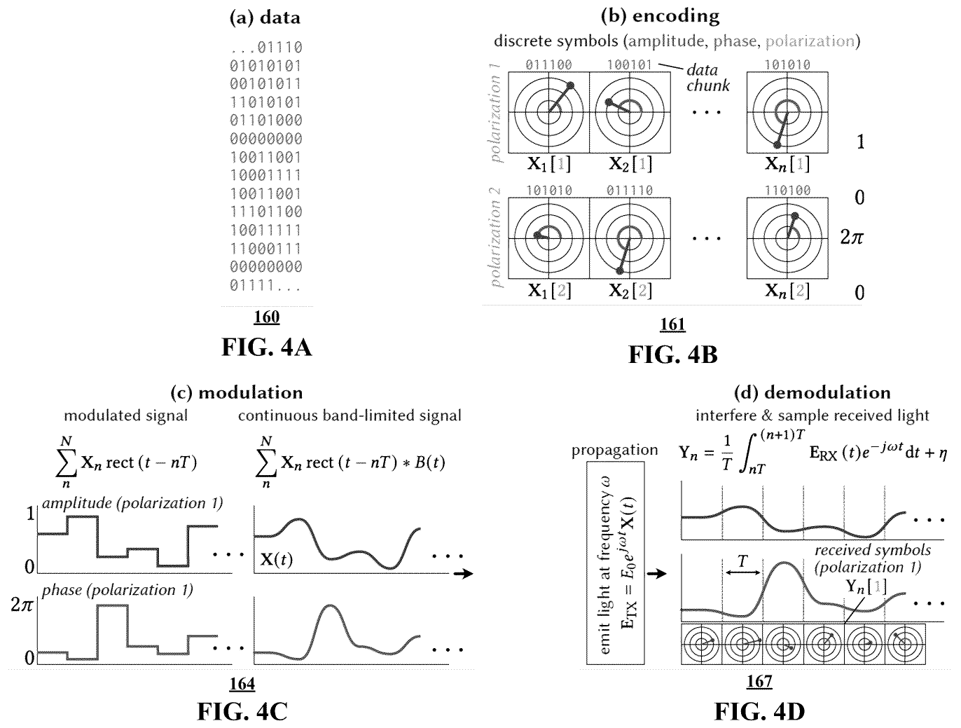

FIGS. 4A through 4D collectively provides an example, non-limiting embodiment of an overview of data transmission in coherent optical modems. In more detail, FIG. 4A is an example, non-limiting embodiment of data collection, e.g., resulting in an example segment of data 160 in accordance with various aspects described herein. The data is arranged according to data segments or chunks, e.g., arranged in a single column for clarity. For example, the data segments or chunks include bytes of binary data.

FIG. 4B is a schematic diagram illustrating an example, non-limiting embodiment of encoded data 161, e.g., corresponding to the example segment of data 160 of FIG. 4A in accordance with various aspects described herein. The encoding results in a discrete sequence of symbols Xₙ, each paired with a certain amplitude, phase, and polarization state of light. For example, the binary data can be encoded into symbols having an amplitude, a phase and a polarization according to the example segment of data 160 of FIG. 4A. For example, the first six bits “0110101” can be associated with a first symbol, corresponding to a first polarization, e.g., X₁[1] and the next six bits “101010” can be associated with a first symbol, corresponding to a second polarization, e.g., X₁[2]. Likewise, the next six bits “100101” can be associated with a second symbol corresponding to a first polarization, X₂[2] and the following six bits “011110” can be associated with a second symbol corresponding to the second polarization, X₂[2], and so on.

FIG. 4C is a modulation graph 164 illustrating an example, non-limiting embodiment of a modulation signal that may result from an application of the encoded data of FIG. 4B to a physical signal, in accordance with various aspects described herein. The example sequence of symbols can be used to create a piecewise constant waveform, e.g., with segments of a particular duration, T (shown for a single polarization). A left-hand portion of the modulation graph 164 provides amplitude and phase of a first polarization of a stepwise modulation signal. A similar signal can be obtained for the second polarization of the example dual polarization application. In practice, a band-limited version of this waveform modulates laser light with amplitude E0 and wavelength λ=c 2πω, where ω/2π is the optical frequency and c is the speed of light. A right-hand portion of the modulation graph 164 provides amplitude and phase of a first polarization of a continuous, band-limited signal as may result from imposing bandwidth limits to the pulsed signal of the left-hand portion of the modulation graph 164.

FIG. 4D is a demodulation graph 167 illustrating an example, non-limiting embodiment of demodulation of a received waveform corresponding to the modulation graph 164 of FIG. 4C. In at least some applications, the modulation graph 164 can be applied to a physical signal suitable for propagation through a physical medium. For example, an RF signal propagated through free space may be subjected to propagation effects, e.g., losses, fading, interference over a channel in accordance with various aspects described herein. In at least some embodiments, the modulated light can be emitted, collected by a receiver, and interfered with an unmodulated receiver-side laser to remove the optical frequency shift. The resulting waveform is sampled to recover the demodulated symbols Yₙ.

By way of example, a coherent optical modem can be operated on a single wavelength channel at 1550 nm; this wavelength has the benefit of being eye safe at roughly 50× higher transmit powers (up to 10 mW) compared to visible wavelengths because light is absorbed at the cornea rather than propagating to the retina.

A simple modulation scheme can be used, e.g., consisting of random amplitude and phase values sampled from a complex Gaussian distribution—the optimal scheme for measurements corrupted by Gaussian noise. Modulated light can be transmitted on two orthogonal polarization channels which can be coupled to free space and backscattered from surfaces with different material properties. As such, the transmitted light signals may be distorted by speckle, and/or polarization and/or phase information is scrambled. An estimate, e.g., an explicit estimate, of these distortions can be obtained to recover depth and/or velocity.

### Coherent Optical Modem Imaging.

Coherent modems can be designed to enable high-bandwidth transmission of data over optical fiber. Achieving data rates of many gigabits per second necessitates exploiting multiple degrees of freedom in the transmitted light. In this section, the working principle of optical modems is addressed—from encoding digital information into discrete symbols, to transmitting, receiving, and demodulating the digital data. Also addressed is how optical modems can be repurposed for imaging in free space.

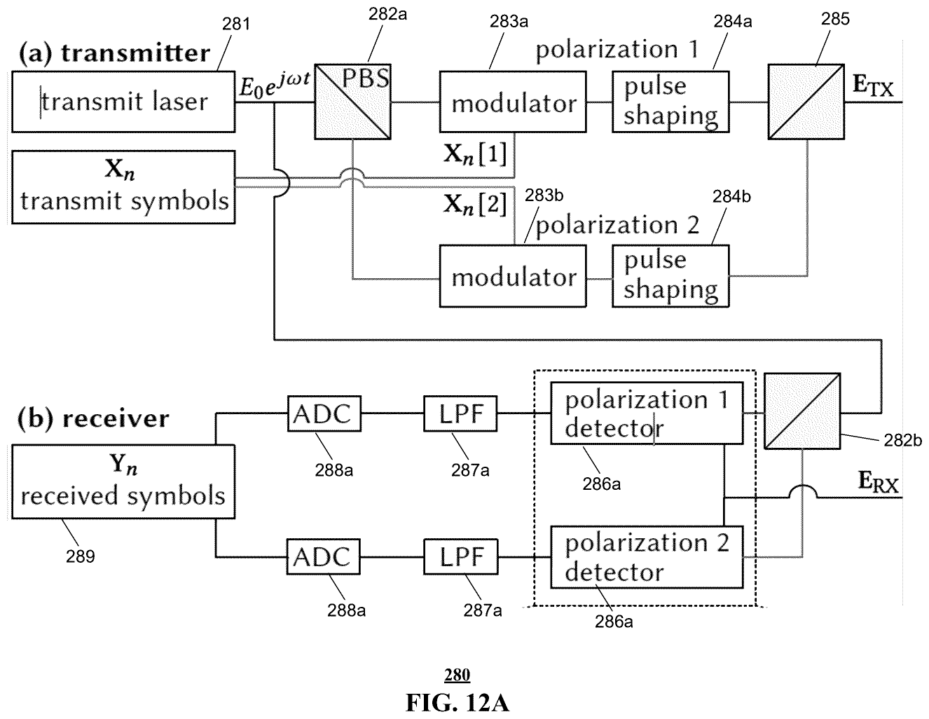

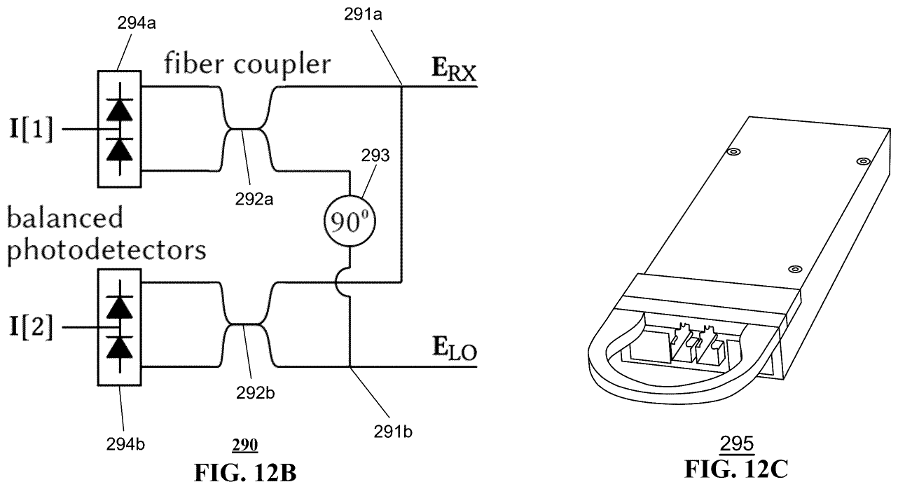

Coherent Modulation and Demodulation. In at least some embodiments, a coherent optical modem can realize at least two functionalities, e.g., modulation of a coherent laser, where a predefined data sequence is encoded into a laser's electric field and demodulation of received light, where the transmitted data sequence is inferred from a measured electric field (see, e.g., FIGS. 12A-12B).

Modulation. By way of example, a coherent modem is considered that modulates a phase and amplitude of light in two orthogonal linear polarization states. Given an input sequence of digital data, e.g., the example segment of data 160 of FIG. 4A, a complex-valued matrix X∈C2×N can be defined that can be used to map digital data to different output states of a coherent laser. More specifically, each column of this matrix, denoted by Xn, contains two complex-valued symbols that specify the phase and amplitude of the outgoing electric field at each polarization during the n^{th} output time interval, or symbol period: nT≤t<(n+1)T. Example mappings are shown in the encoded data 161 of FIG. 4B.

Once the digital data are encoded into symbols, the example modulation process involves two steps. First, the discrete sequence of symbols Xₙ is transformed, e.g., as shown in the left-hand side of the example modulation graph 164 of FIG. 4C, into a continuous coded waveform X(t):

$$X ( t ) = {\sum }_{n = 0}^{N - 1} {X}_{n} rect ( t - nT ) * B ( t ) . \qquad ( Eq . 1 )$$

The term “rect(t)” is a rectangular function that is equal to one for 0≤t<T and zero elsewhere, and B(t) is a filter that creates a smooth, band-limited signal from the piecewise concatenation of rectangular functions e.g., as shown in the right-hand side of the example modulation graph 164 of FIG. 4C. Second, the coded waveform can be used to modulate a laser of wavelength λ=c 2π whose electric field propagates at the speed of light c and oscillates with carrier frequency ω/2π and amplitude E₀. The transmitter output of the coherent optical modem can then be formulated as

$${E}_{TX} ( t ) = {E}_{0} {e}^{j ω t} X ( t ) , \qquad ( Eq . 2 )$$

such that the digital information is completely encoded in the transmitted electric field ETX.

Demodulation. The goal of demodulation is to recover an estimate Yn of the transmitted symbol sequence Xn by measuring the amplitude and phase of received electric field ERX (t). Either homodyne or heterodyne coherent detection can be used, where the measured electric field is interfered with a laser source called the local oscillator. For at least some embodiments in the context of optical communications, the transmitted signal and the local oscillator can be generated by different laser sources, e.g., the phase of the local oscillator can be matched to that of the received signal using a phase-locked loop and/or feed-forward carrier synchronization, which can be configured to maintain temporal coherence.

In a homodyne detection scheme, the received signal and local oscillator have the same carrier frequency ω/2π. Interference of these two sources downconverts the received signal: the high-frequency oscillations of the electric field at the laser frequency are removed, and the modulated waveform containing the encoded digital data is recovered (refer to the supplement for a mathematical description of this procedure). The detected sequence Yn, e.g., as shown in the example demodulation graph 167 of FIG. 4D, is given as:

$${Y}_{n} = \frac{1}{T} {\int }_{nT}^{( n + 1 ) T} {E}_{RX} ( t ) {e}^{- j ω t} dt + η . \qquad ( Eq . 3 )$$

Here, the received electric field, after interference with a local oscillator, can be sampled, e.g., via integration over a symbol period. According to the illustrative example, the term η is complex Gaussian noise that can incorporate multiple effects, including one or more of thermal noise in the receiver, shot noise, and/or noise due to inline optical amplifiers.

It is worth noting here that this section provides a simplified description of an example coherent modulation and demodulation procedure. It is understood that in at least embodiments, optical modems may contain additional optical and/or digital processing stages, e.g., to ensure that the local oscillator is locked to the transmit laser and/or that a received signal is sampled with a correct timing. It is also worth noting that the example Gaussian noise model neglects secondary effects such as optical fiber non-linearities.

Repurposing Coherent Optical Modems for Imaging. In at least some embodiments, a coherent optical modem as may be configured for communications applications can be reconfigured and/or otherwise repurposed for the task of scene properties, e.g., that may include depth and/or velocity measurements as may be used for free-space 3D imaging. For example, given a known transmit symbol sequence and a received symbol sequence, unknown scene parameters can be inferred that may include, without limitation, one or more of depth, radial velocity, and/or change in polarization state. In contrast to communication systems where the transmitted sequence is unknown and the task is to recover the digital data, the various applications disclosed herein understanding how transmitted waveforms may be distorted by a propagation channel and, in turn, to recover scene properties.

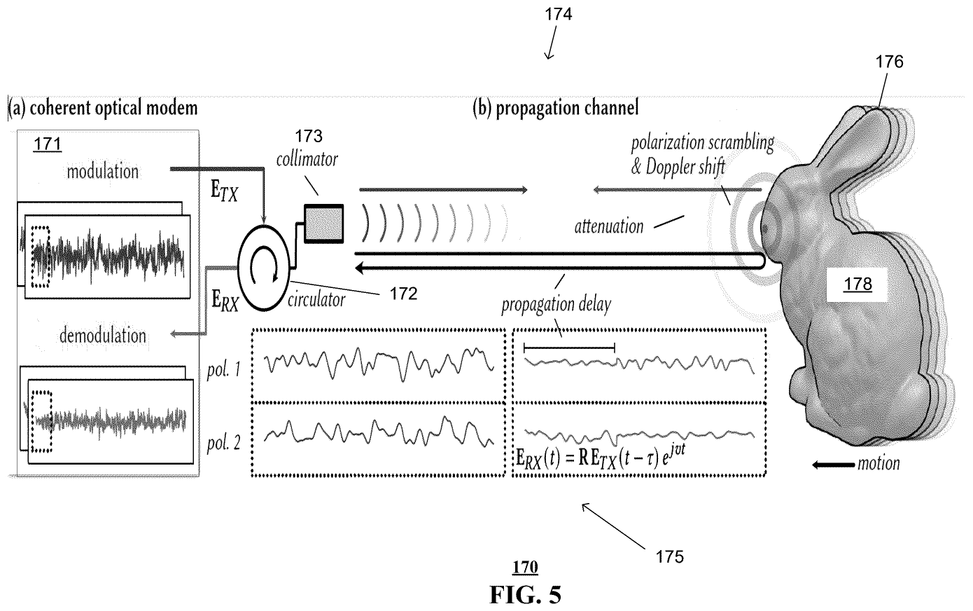

System overview. FIG. 5 provides an overview of scenic analyzer system 170 that utilizes an optical modem 171 to simultaneously measure scenic properties that may include one or more of distance, axial velocity, and/or polarization. In at least some embodiments, the scenic analyzer system 170 can be applied to an imaging system based on coherent optical modems. The optical modem 171 modulates the laser electric field based on an arbitrary, known symbol sequence, and the light is transmitted to the scene through a fiber optic cable and collimator that directs the light to/from the scene via a propagation channel 174. In this example, the scene includes an object, e.g., a target 178 having a surface 176. The example imaging system 170 includes a circulator 172 and a collimator 173. The reflected light reflected from the surface 176 of the target 178 can be collected by the same collimator 173 and directed to the optical modem 171. According to the illustrative example setup, a transmitter and receiver of the optical modem 171 share the same light propagation path through the circulator 172 (which can be configured to separate optical signals traveling in opposite directions), and use a set of scanning mirrors 108 (FIG. 1A) to image the scene.

Measurement model. A received and demodulated electric field E_{RX}(t) 175 may be corrupted, e.g., by three at least three effects resulting from propagation to the scene and back via the propagation channel 174. First, the demodulated electric field is time-shifted relative to the transmit signal due to the propagation delay to the target and back. Second, if illuminating a moving target, the field may be frequency-shifted due to a Doppler effect. Finally, the field may be distorted by attenuation and changes in the polarization state due to the surface reflection. The received electric field 175 can therefore be modeled as

$${E}_{RX} ( t ) = {RE}_{TX} ( t - τ ) {e}^{j ν t} . \qquad ( Eq . 4 )$$

The terms τ and ν denote the propagation delay and frequency shifts of the demodulated electric field. The Jones matrix R is a 2×2 complex-valued matrix that describes how the transmitted electric field is transformed by a polarization-dependent attenuation and rotation induced by the properties of the target surface and propagation through the fiber).

In practice, it may be assumed that the received, down converted electric field is approximately constant over the symbol integration period, allowing the integral in Eq. 3 to be dropped, such that the received symbol sequence Yn can be directly related to the transmitted sequence as illustrated in Eq. 5:

$${Y}_{n} = {RX}_{n - Δ} {e}^{j ν t} + η . \qquad ( Eq . 5 )$$

where Δ=[τ/T] represents an integer shift in the symbol sequence due to the propagation delay. This integer approximation to the time delay (i.e., τ/T≈[τ/T]) may be justified for situations in which τ>>T.

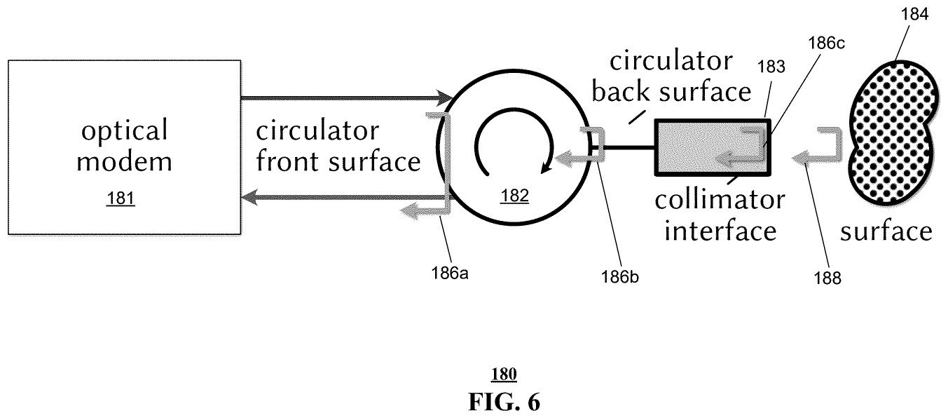

FIG. 6 is a block diagram illustrating an example, non-limiting embodiment of a scenic analyzer system 180, in accordance with the various aspects described herein. In more detail, the scenic analyzer system 180 is based on a FWL prototype using a coaxial lidar systems. It has been observed that such a system 180 may be subjected to nonidealities such as reflections from interfaces in the optical path. According to the illustrative example, the scenic analyzer system 180 includes an optical modem 181, a circulator 182 and a collimator 183. A transmit signal originating from the optical modem 181 is directed toward a surface of a scenic element or target 184. At least a portion of the incident light signal is reflected 188 and/otherwise scattered, referred to generally as backscatter, by the surface of the target 184. At least a portion of the backscattered light is returned toward a receiver of the optical modem 181, e.g., via the collimator 183, and the circulator 182.

It may be appreciated that coaxial lidar configurations may exhibit inter-reflections, e.g., caused by the various interfaces in the optical propagation path. For example, at least some reflections 186a, 186b, 186c, generally 186, may occur at one or more of an input and/or an output of the circulator 182, the collimator 183, while other reflections 188 may result from surfaces of the target 184. Additional reflections from partially transparent surfaces in the scene may also be possible. Thus, in at least some embodiments, measurements from the example scenic analyzer system 170 can be modeled as a superposition of signals, e.g., including multiple inter-reflections and scene reflections as depicted in the example scenic analyzer system 180. It is understood that reflection 188 off of surfaces of the target 184 are of primary interest, other reflections 186 may captured, e.g., from interfaces of the circulator 182, and from the glass-air interface of the collimator 183. Since these reflections 186 due to internal surfaces are static, they do not induce a Doppler shift. A generalization of Eq. 5 can be considered that models the received symbol sequence as a discrete superposition of the delayed, polarization-scrambled, and potentially frequency-shifted copies of the transmitted signal:

$${Y}_{n} = {\sum }_{s = 0}^{S - 1} {R}_{s} {X}_{n - {Δ}_{s}} {e}^{j {ν}_{s} t} + η . \qquad ( Eq . 6 )$$

Here, s denotes the index of each copy of the transmitted signal; Rₛ and Δₛ=[τₛ/T] model the corresponding polarization scrambling, signal attenuation, and propagation delay; and νₛ is the corresponding Doppler shift (zero for internal reflections).

Given a known transmitted symbol sequence, a per-pixel scene unknowns can be recovered from the received symbol sequence, e.g., through maximum likelihood estimation:

$$\{ {R}_{s}^{*} , {Δ}_{s}^{*} , {v}_{s}^{*} \} = {arg max}_{\{ {R}_{s}^{*} , {Δ}_{s}^{*} , {v}_{s}^{*} \}} Pr ( {Y}_{n} \vert {X}_{n} ) . \qquad ( Eq . 7 )$$

For each pixel, Δ*ₛ is an estimate of the depth ds=Δ*·T c/2, where c is the speed of light. The velocity is calculated from the Doppler shift as (ν*ₛ·c)/ω, and R describes the attenuation and polarization change, which depend on the surface and material.

### Joint Estimation of Depth, Velocity, and Polarization.

In at least some embodiments, an example optimization algorithm can be provided, e.g., for joint estimation of any combination of depth, radial velocity, and/or polarization changes at each pixel.

Matched filtering. In the case of a single direct reflection (S=1 in Eq. 6), no polarization scrambling, and additive Gaussian noise, the matched filter is the maximum-likelihood estimator for recovering the unknown propagation delay of a known transmit waveform. The matched filter is also the typical approach for depth estimation in RMCW lidar. Using the notation of Eq. 7, matched filtering can be expressed as the optimization

$${Δ}^{*} = arg {max}_{Δ} {\vert {\sum }_{Δ = - ∞}^{∞} {X}_{n - Δ} {Y}_{n} \vert}^{2} , \qquad ( Eq . 8 )$$

where X̅ₙ̅ is the complex conjugate of the transmitted symbol Xₙ.

Joint estimation. While matched filtering offers a straightforward and computationally efficient solution to depth estimation, it may not be well-suited for complex scenes. For example, in the general case captured by Eq. 6, no single time delay can explain the received symbol sequence because of polarization scrambling, Doppler shift and multiple reflections. By ignoring these effects, the optimization in Eq. 8 provides no substantial information about the velocity and polarization properties of scene points. Proper handling of these effects would be important, not only for FWL, but for any lidar system—multiple reflections can be caused by depth discontinuities or partially transparent surfaces. In coherent lidar, Doppler shifts can be modeled for accurate depth estimation and velocimetry for dynamic scenes.

Instead, the values of R, Δ, and ν are sought, as well as the number of shifted copies of the transmitted symbols S, that minimize the mean squared error between the transmitted and received symbols, described as follows:

$${arg min}_{\{ S , {R}_{\text{?}} , {Δ}_{\text{?}} , {v}_{\text{?}} \}} {\sum }_{n = 0}^{N - 1} {‖ {Y}_{n} - {\sum }_{s = 0}^{S - 1} {R}_{s} {X}_{n - {Δ}_{k}} {e}^{j {v}_{k} t} ‖}_{2}^{2} . \qquad ( Eq . 9 )$$

$$\text{?} \text{indicates text missing or illegible when filed}$$

Solving this problem provides the maximum likelihood estimate of these parameters under a Gaussian noise model. This approach is analogous to channel estimation employed in the digital communications literature.

The optimization in Eq. 9 does not have a closed-form solution; the associated objective function is combinatorial in nature because of the (typically small and unknown) number of additive terms. To make optimization tractable, the objective can be relaxed by discretizing the space of Doppler shifts and associating an unknown Jones matrix R_{Δ,ν} to each possible time delay Δ and Doppler shift ν.

$${ℒ}_{data} = {\sum }_{n = 0}^{N - 1} {‖ {Y}_{n} - {\sum }_{Δ , v} {R}_{Δ , v} {X}_{n - Δ} {e}^{jvt} ‖}_{2}^{2} . \qquad ( Eq . 10 )$$

Since a relatively small number of contributions are expected to the sum of Eq. 9, a sparsity-promoting regularization term Lₛₚₐᵣₛₑ is introduced into an objective function. A total variation spatial regularization term LTV can also be introduced to help mitigate errors across pixels due to speckle noise, e.g., by encouraging spatial smoothness in the energy of the reconstructed Jones matrices:

$${ℒ}_{sparse} = {\sum }_{Δ , v} {‖ {R}_{Δ , v} ‖}_{F} , and \qquad ( Eq . 11 )$$

$${ℒ}_{TV} = {\sum }_{i , j , Δ , v} \sqrt{{\vert {( {D}_{v} {‖ {R}_{Δ , v} ‖}_{F} )}_{i , j} \vert}^{2} + {\vert {( {D}_{h} {‖ {R}_{Δ , v} ‖}_{F} )}_{i , j} \vert}^{2}} . \qquad ( Eq . 12 )$$

Here, ∥·∥_{F} is the Frobenius norm, Dᵥ and Dₕ compute vertical and horizontal finite differences between pixels, and i and j index the vertical and horizontal pixel locations. The resulting optimization problem is

$${arg min}_{{R}_{Δ , v}} {ℒ}_{data} + {λ}_{sparse} + {ℒ}_{sparse} + {λ}_{TV} {ℒ}_{TV} . \qquad ( Eq . 13 )$$

where the scalars λₛₚₐᵣₛₑ and λ_{TV} weigh each regularizer.

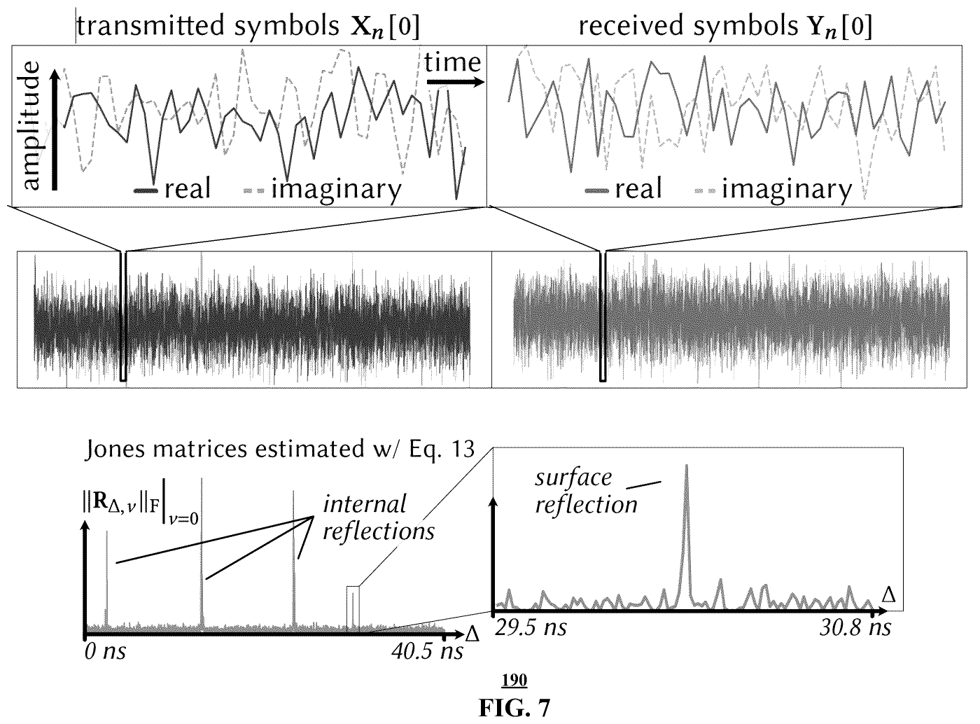

FIG. 7 includes graphs 190 illustrating an example, non-limiting embodiment of an application of estimated Jones matrices. Top and middle portions of the example graphs 190 reflect transmitted and received symbols, whereas, the bottom portion of the example graphs 190 relates to a sequence of Jones matrices R_{Δ,ν}. According to the illustrative examples, the transmitted and received symbols can be related by a function, e.g., a convolution, with a sequence of Jones matrices R_{Δ,ν}, such as those provided in the example and estimated using Eq. 13. The real and imaginary symbol components illustrated in the top portions of the example graphs 190 describe amplitude and phase (FIGS. 12A-12C). According to the illustrative example, ∥R_{Δ,ν}∥F is provided in the bottom of the graphs 190 for a static scene with ν=0.

Once the Jones matrices have been estimated for all Δ and ν, the depth and velocity can be solved for as follows. Given that a scene contains a single reflection from a target surface, the delay Δ and frequency shift ν can be returned, whose associated Jones matrix has the maximum Frobenius norm (and we ignore delays due to internal reflections). That is, it can be found that:

$$( {Δ}^{*} , {v}^{*} ) = {arg min}_{Δ , v} {‖ {R}_{Δ , v} ‖}_{F} subject to > {Δ}_{min} , \qquad ( Eq . 14 )$$

where Δₘᵢₙ is the minimum delay due to free-space propagation, ignoring internal reflections in the optical modem.

Implementation Details—Optimization. By way of example, the optimization in Eq. 13 can be implanted in PyTorch and Adam can be used with a learning rate of 1×10⁻². For the weighting of loss terms λₛₚₐᵣₛₑ=0.1 can be used for static scenes and λₛₚₐᵣₛₑ=0.3 can be used for dynamic scenes, with Δ_{TV}=0.1. In practice, to ease computational requirements, the TV loss can be applied to Jones matrices across the A dimension where ν=0 (i.e., to the static scene components). Similarly, for dynamic scenes a maximum axial velocity of 30 meters/second can be set, and optimizing only for the feasible frequency shifts.

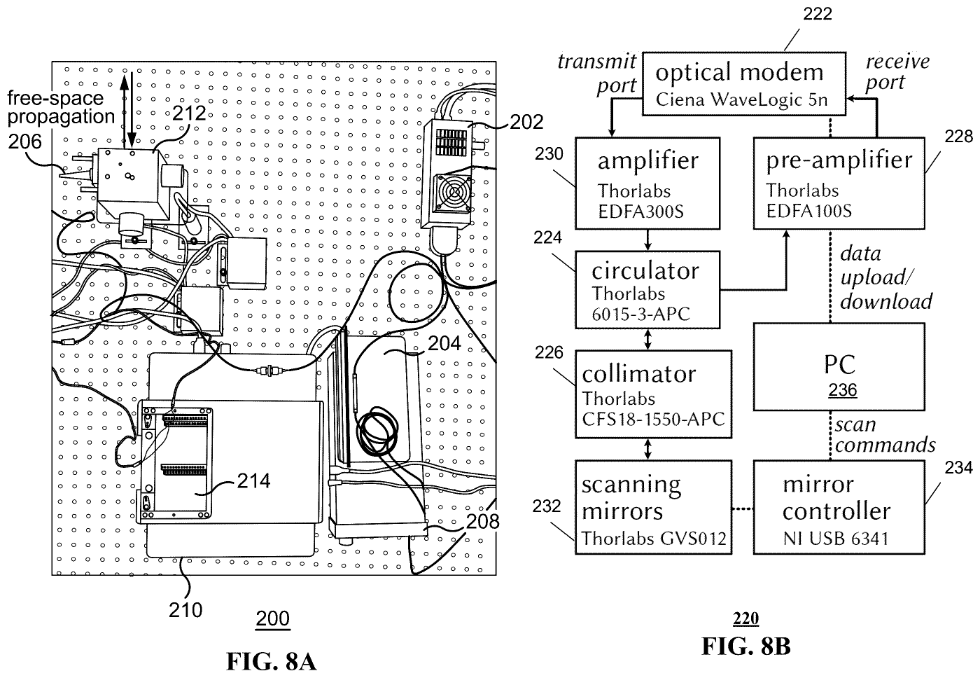

Hardware prototype. FIG. 8A is a photograph illustrating an example, non-limiting embodiment of a hardware prototype of an image scanning system 200, in accordance with various aspects described herein. The image scanning system 200 includes an optical modem 202, a circulator 204, a collimator 206, a pre-amplifier 208, an amplifier 210, scanning mirrors 212 and a mirror controller 214.

According to the illustrative example, the modem 202 included a Ciena WaveLogic 5n modem with a sampling frequency of 1/T=74 GHz (i.e., an optical path resolution of 4 mm or depth resolution of 2 mm). A laser of the modem 202 operated at a wavelength of 1550 nm. The modem 202 was communicated with over its QSFP-DD electrical interface, e.g., to program the transmit sequence and to read out the measured data. The transmitted sequence length, limited by finite modem memory, was set to ≈216 symbols, providing a maximum unambiguous range of approximately 130 meters. The amplifier 210 included an Erbium-doped fiber amplifier (EDFA) to boost the power of the emitted laser light from about 1 mW up to a maximum of about 100 mW. Experiments conducted with the hardware prototype of the image scanning system 200 used an eye-safe transmit laser power of about 2 mW unless otherwise specified. Another EDFA was used as a pre-amplifier 208 to boost the power of the received light up to the level expected by the modem (roughly 1 mW).

FIG. 8B is a block diagram illustrating an example, non-limiting embodiment of a scanning system 220, such as the hardware prototype scanning system 200 (FIG. 8A), in accordance with various aspects described herein. The example image scanning system 220 includes an optical modem 222, a circulator 224, a collimator 226, a preamplifier 228, an amplifier 230, scanning mirrors 232 and a mirror controller 234. The example scanning system 220 also includes a controller, e.g., a PC 236. The PC 236 is in communication with the optical model 222, e.g., via the preamplifier 228. The PC 236 can be used in an upload and/or a download of data processed by the scanning system 220. In at least some embodiments, the PC 236 is also in communication with one or more other components and/or subsystems of the scanning system 220, such as the mirror controller 234, e.g., to monitor, control and/or otherwise coordinate operation of the scanning mirrors 232 with operations of the scanning system 220.

### Experimental Results

The FWL system was evaluated across different exposure settings, and compared to alternative modulation schemes and reconstruction techniques. In at least some embodiments, the FWL approach was demonstrated, without limitation, for recovery of one or more of depth and/or velocity information, imaging through translucent media, imaging under strong ambient light, reconstructing objects with sub-surface scattering, and reconstruction of room-scale scenes.

Quantitative and Comparative Evaluation—Generalized matched filtering. Joint estimation framework can be compared to a straightforward generalization of matched filtering which incorporates the multiple polarization channels of FWL. Specifically, Eq. 8 can be modified to correlate the transmit and received symbols sequences across both polarization channels:

$${Δ}^{*} = arg {max}_{Δ} {\sum }_{p , q} {\vert {\sum }_{Δ = - ∞}^{∞} {\overline{X}}_{n - Δ} [ p ] {Y}_{n} [ q ] \vert}^{2} , \qquad ( Eq . 15 )$$

where p, q∈{1, 2} index the polarization channels. While this procedure is convenient because it incorporates information across polarization channels, it does not recover Doppler frequency shift, nor does it recover the complex-valued Jones matrices corresponding to reflections.

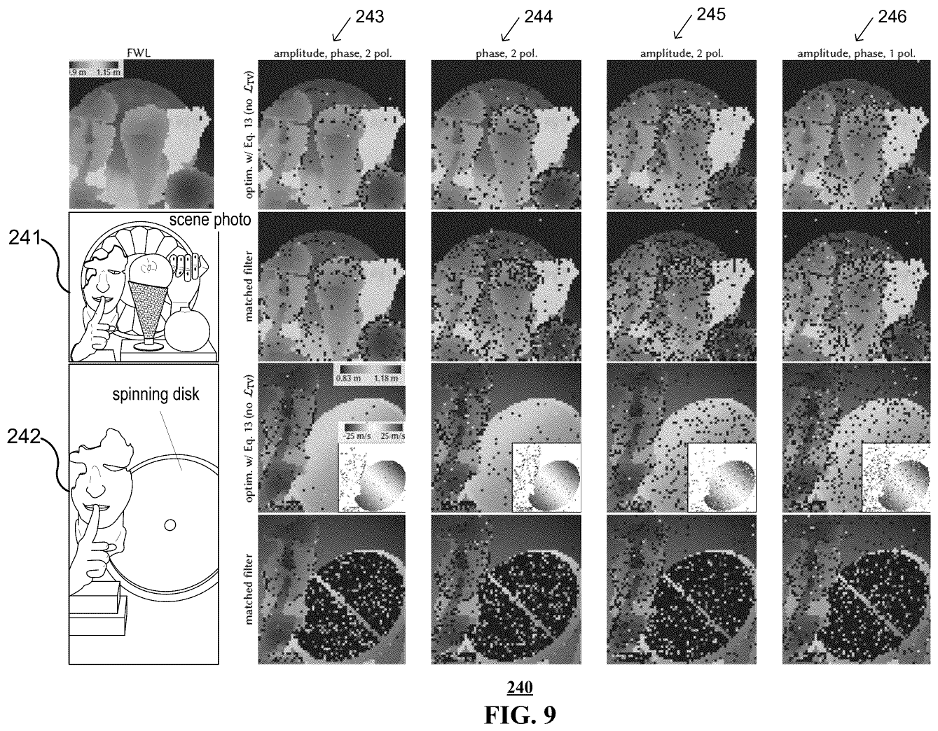

Comparison to other modulation schemes. FIG. 9 illustrates test results 240 including photographic images of example scenes 241, 242 for evaluation by various scanning systems including a full-wave lidar system, in accordance with various aspects described herein. FIG. 9 also illustrates graphical images illustrating example, non-limiting embodiments of processed results example scenes 241, 242 presented in FIG. 1B by the various scanning systems including a full-wave lidar system, in accordance with various aspects described herein. Scanned results of the FWL approach 243 were compared to results of other modulation schemes emulated with the coherent optical modem. Specifically, results of the FWL approach 243 were compared to results obtained using dual-polarization phase-only modulation 244, results obtained using dual-polarization amplitude-only modulation 245, and results obtained using single-polarization phase and amplitude modulation 246 (see supplemental discussion hereinbelow for implementation details). FIG. 9 allows for a comparison between modulation schemes and optimization techniques. For example, in rows 1 and 3 correspond to FWL results, e.g., the amplitude and phase modulation across two polarization channels, to phase-only modulation, amplitude-only modulation, and single-polarization modulation of phase and amplitude without LTV. Further, rows 2 and 4, correspond to results using generalized matched filtering. It is apparent that the FWL optimization based on Eq. 13 shows a more robust performance when compared to other modulation schemes and the generalized matched filter, which also fails to recover accurate depth for Doppler-shifted pixels.

It is apparent from the results that the FWL approach recovers depth maps with fewer outliers compared to the other modalities and compared to depth estimation using generalized matched filtering. Depth precision was assessed by imaging a planar target at distances of roughly 0.5, 1.0, and 1.5 meters and reporting the mean depth error to a plane fitted to each measurement. It was observed that FWL outperforms other modalities that do not use all the available degrees of freedom for modulating light (Table 1).

TABLE 1
Evaluation of depth precision.

| | | | % of pixels with depth | | % of pixels with depth | |
|---|---|---|---|---|---|---|
| | mean depth error (mm) | | error < 2 mm 1 joint | | error < 6 mm 1 joint | |
| | joint gen. | | estimation gen. | | estimation gen. | |
| Method | estimation matched filter | | matched filter | | matched filter | |
| FWL | 4.43 | 9.93 | 65.20 | 64.77 | 98.50 | 97.78 |
| dual- | 9.31 | 24.99 | 57.16 | 55.40 | 97.91 | 94.92 |
| polarization | | | | | | |
| phase | | | | | | |
| dual- | 19.08 | 39.51 | 58.59 | 55.72 | 95.96 | 91.92 |
| polarization | | | | | | |
| and amplitude | | | | | | |
| single- | 30.19 | 46.95 | 47.85 | 45.83 | 93.75 | 90.46 |
| polarization | | | | | | |
| phase and | | | | | | |
| amplitude | | | | | | |

A planar surface was scanned and deviation of the measurements to a plane fitted to the surface were determined. The performance was compared using the generalized matched filter; note that the TV regularizer was omitted for this evaluation to assess per-pixel precision.

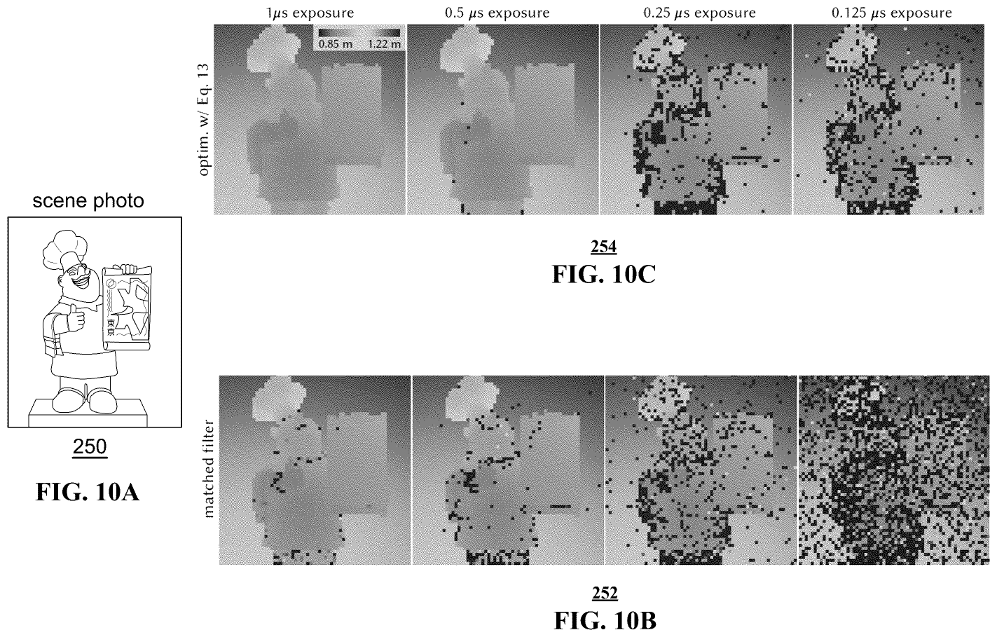

Robustness to noise. FIG. 10A is a photographic image of an example scene 250 for evaluation by the example techniques disclosed herein, in accordance with various aspects described herein. FIG. 10B presents graphical images illustrating example, non-limiting embodiments of processed results 252 of the example scene 250 presented in FIG. 10A using a matched filter and obtained at various exposure settings, in accordance with various aspects described herein. FIG. 10C presents graphical images illustrating example, non-limiting embodiments of processed results 254 example scene 250 presented in FIG. 10A, optimized according to Eq. 13 and obtained at various exposure settings, in accordance with various aspects described herein. In more detail, example method was evaluated using different per-pixel exposure settings (e.g., from about 0.125 microseconds to about 1 microsecond) while maintaining the same transmit power. At shorter exposure settings the quality of depth estimation degrades as illustrated in FIGS. 10B and 10C; however, the approach demonstrated better performance at low signal to noise ratios compared to generalized matched filtering.

### Imaging Demonstrations

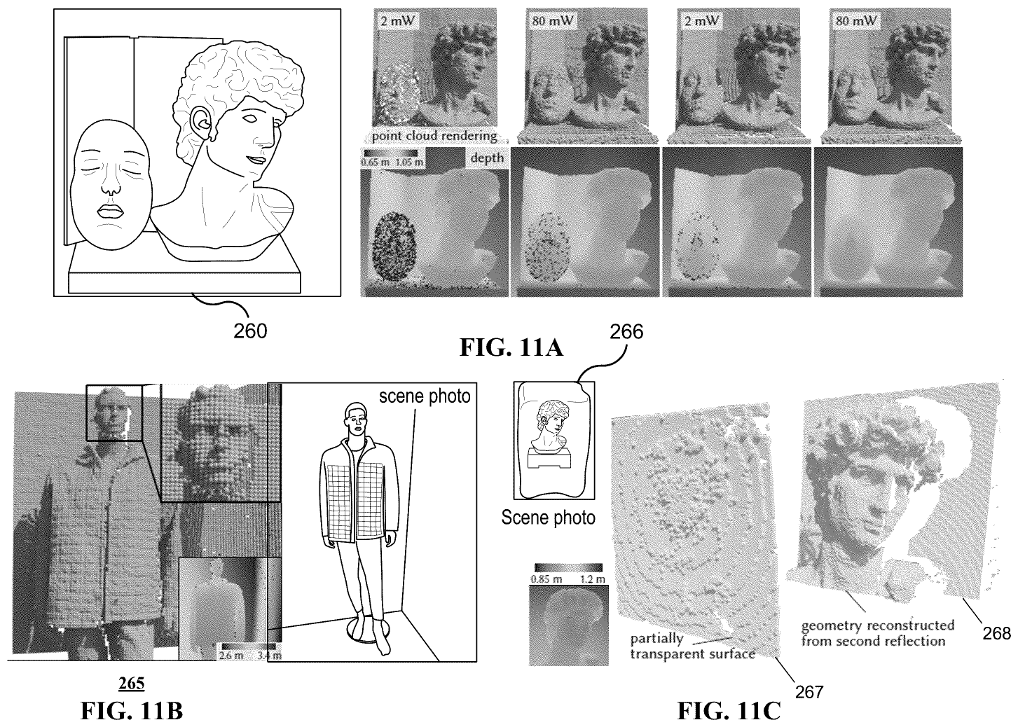

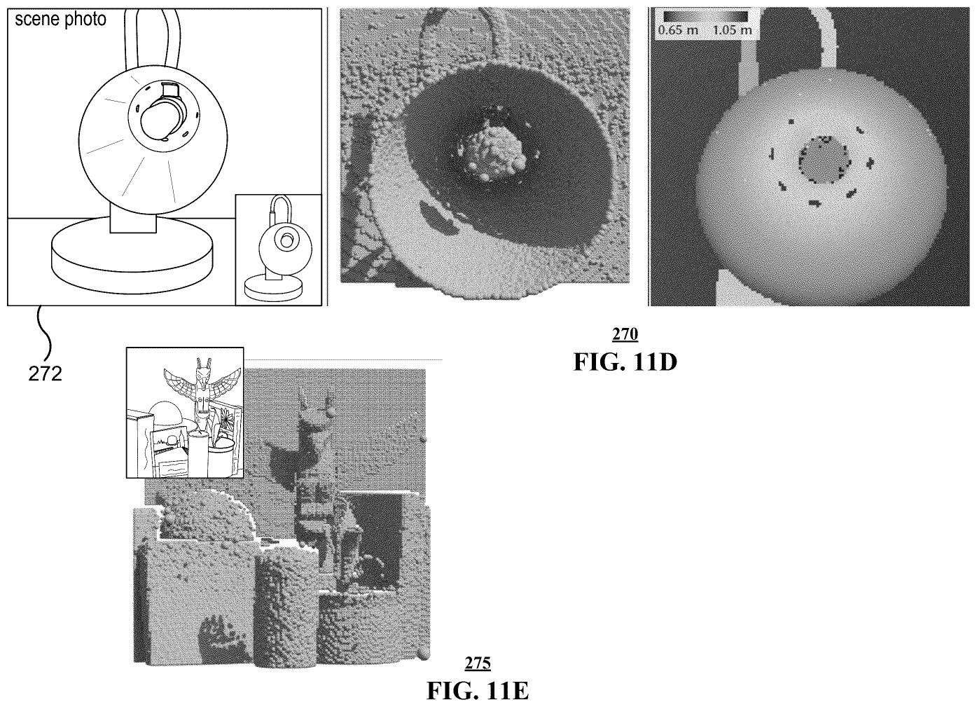

Recovering depth and velocity. In FIG. 1 a scene is shown as being illuminated by sunlight (e.g., through a window) containing static objects and a spinning hemisphere. The radial velocity of the hemisphere is estimated to be a maximum of 25 m/s, which agrees with estimates produced using a high-speed camera (see supplement). Depth is recovered despite the presence of strong ambient light from the sun, which illuminates the scene through the window (see FIG. 11 for a point cloud reconstruction).

Challenging materials and room-sized scenes. FIGS. 11A through 11D present a photographic images and corresponding processed results of different imaging approaches in, so called, challenging imaging scenarios, in accordance with various aspects described herein. In particular, FIG. 11A presents a photographic image 260 of a scene including a diffuse statuette and mask made from translucent material. The photographic image 260 is presented next to graphical results 262 presented reconstructed objects of the scene. These results 262 demonstrate reconstructing objects with subsurface scattering and detailed geometry and provide a comparison to generalized matched filtering using optical powers of 2 mW and 80 mW. In each case the qualitative results presented in FIG. 11A through 11D show robust reconstruction of the scene geometry. Similar trends were observed in results 265 obtained for a larger room-sized scene captured with FWL and as presented in FIG. 11B.

Imaging through translucent media. FIG. 11C shows a photograph an example scene 266 in which a statuette is placed behind a translucent surface. The illustrative optimization procedure recovers both surfaces as shown in the reconstructed point clouds 267, 268.

Strong ambient light. FIG. 11D shows an example scene in which the image is obtained under strong ambient light. As demonstrated by the example results 270, the geometry of a tungsten halide light bulb 272 can be reconstructed while it is turned on. While the bulb's spectrum includes the 1550 nm wavelength used for FWL, the system is extremely robust to ambient light due to the homodyne detection scheme. FIG. 11E shows another example point cloud visualization 275 of a complex scene.

Coherent optical modems are a promising solution to make coherent lidar more accessible to researchers and practitioners. Still, some barriers remain to the widespread adoption of this technology. For example, using fast optical modems (operating at tens to hundreds of GHz) requires domain knowledge to program and read out the transmitted and received waveforms. According to the example, non-limiting embodiments, it has been observed that a hardware interface to the modem requires around one second to transfer data to a computer after each exposure; this limits the acquisition speeds of the current system to more than a second per scan point and thus limits the overall scan resolution. It is understood that refinement of the hardware interface using available techniques can overcome the limits observed during prototyping It is understood that with such refinements, the techniques can be applied to real-time capture of depth and velocity. It can be realized that FWL also offers benefits for other imaging scenarios, such as in the presence of scattering media, where sensitivity to motion, depth, and polarization could help to isolate unscattered light.

### Coherent Modulation and Demodulation.

Homodyne detection. For completeness, a detailed mathematical description of a homodyne detection procedure that was introduced in Section 3 of the paper is provided hereinbelow. For simplicity, the effects of phase noise and amplified spontaneous emission noise are ignored in this derivation; these can be gathered into a single term consisting of complex Gaussian noise as will be addressed later.

Recall from the main text that the transmit and received electric fields can be written as

$${E}_{TX} ( t ) = \sqrt{{P}_{TX}} {e}^{j ω t} X ( t ) , \qquad ( Eq . S1 )$$

$${E}_{RX} ( t ) = R {E}_{TX} ( t - τ ) {e}^{jvt} = \sqrt{{P}_{TX}} R X ( t - τ ) {e}^{jvt} {w}^{j ω t} , \qquad ( Eq . S2 )$$

where PTX is the transmit optical power. Then, write the electric field corresponding to the local oscillator as

$${E}_{LO} ( t ) [ p ] = \sqrt{{P}_{LO}} {e}^{j ω t} , p ∈ \{ 1 , 2 \} . \qquad ( Eq . S3 )$$

where p indexes the polarization channel and PLO is the transmit power of the local oscillator.

FIG. 12A is a block diagram illustrating an example, non-limiting embodiment of a transmit and receive path of a coherent optical modem 280, in accordance with the various aspects described herein. In more detail, a transmit path of the example optical modem 280 includes a transmit laser 281 providing an optical carrier, E₀e^{jωt}, and a first polarizing beam splitter 282a. The first polarizing beam splitter 282a splits the optical carrier into two optical carriers having distinct, different polarizations. The example optical modem 280 further includes two modulator 283a, 283b, one for each of the different polarizations, two pulse shaping filters 284a, 284b, one for each of the different polarizations, and an optical signal combiner 285.

In operation, each of the polarized optical carrier is input to a respective one of the modulators 283a, 283b, and modulated by respective transmit symbols Xₙ[1], Xₙ[2], resulting in two separate polarized, modulated optical signals. In at least some embodiments, each of the polarized, modulated optical signals is filtered by a respective one of the pulse shaping filters 284a, 284b to obtain two separate, polarized, modulated, pulse-shaped optical signals, which can be combined at the optical signal combiner 285.

The example optical modem 280 also includes a receive path including a second polarizing beam splitter 282b in communication with the transmit laser 281 and receiving reference portion of the optical carrier. The second polarizing beam splitter 282b splits the reference portion of the optical carrier into two optical carriers having distinct, different polarizations. The example optical modem 280 further includes two detectors 286a, 286b, one for each of the different polarizations, two low pass filters 287a, 287b, one for each of the different polarizations, and two analog to digital converters (ADC) 288a, 288b.

In operation, each of the polarized reference portions of the optical carrier is input to a respective one of the detectors 286a, 286b, and low-pass filtered by respective low pass filters 287a, 287b, resulting in two detected signals, one for each of the two polarizations. In at least some embodiments, each of the detected signals is filtered by a respective one of the low-pass filters 287a, 287b to obtain two low-pass filtered detected signals, one for each of the two polarizations. Each of the low-pass filtered detected signals is converted to digital format by a respective one of the ADCs 288a, 288b, resulting in two separate digital receive symbols, Yₙ[1], Yₙ[2], one for each polarization, that may be input into a receiver 289 of the example optical model 280 to obtain digital data.

FIG. 12B is a block diagram illustrating an example, non-limiting embodiment of an optical modem receiver 290 that may be included in the example coherent optical modem 280 (FIG. 12A), in accordance with the various aspects described herein. The example optical modem receiver 290 includes first and second optical splitter 291a, 291b, a phase shifter 293, first and second optical couplers 292a, 292b and first and second photodetectors 294a, 294b.

In operation, the first optical splitter 291a splits a received optical signal E_{RX} into two received fields or optical signal portions, and the second optical splitter 291b splits a received optical local oscillator (LO) field or signal ELO into two received optical LO signal portions. A first received optical signal portion is input to one input leg of the first optical coupler 292a and a first received optical LO signal portion is input to one input leg of the second optical coupler 292b. A second received optical signal portion is phase shifted by the phase shifter 293 to obtain a phase-shifted, received optical signal portion. Likewise, a second received optical LO signal portion is phase shifted by the phase shifter 293 to obtain a phase-shifted, received optical LO signal portion. The first received optical signal portion is combined with the first phase-shifted, received optical LO signal portion at the first fiber coupler 292a and provided to the first photodetector 294a to obtain a second photocurrent I[2]. Likewise, the second received optical signal portion is combined with the second phase-shifted, received optical LO signal portion at the second fiber coupler 292b and provided to the second photodetector 294b to obtain a second photocurrent I[2].

FIG. 12C is a photograph illustrating an example, non-limiting embodiment of a coherent optical modem 295, in accordance with the various aspects described herein. The photograph depicts a bottom left perspective view of the coherent optical model 295, which may be configured according to the coherent optical model 280 (FIG. 12A) and/or the example optical modem receiver 290 (FIG. 12B).

According to the illustrative example, the received and local oscillator fields are combined and detected using first and second photodetectors 294a, 294b that include two pairs of balanced photodiodes—one pair for each polarization channel. The photocurrent I[p] at the output of each balanced photodiode can be given as

$$I [ p ] = {\vert {E}_{RX} ( t ) [ p ] + {E}_{LO} ( t ) [ p ] \vert}^{2} - {\vert {E}_{RX} ( t ) [ p ] - {E}_{LO} ( t ) [ p ] \vert}^{2} , \qquad ( Eq . S4 )$$

where the sign change in the second term comes from a 90° phase shifter and an additional 90° phase shift induced by the fiber coupler (see FIG. S1).

Expanding the first term (and dropping dependencies on t for convenience) yields

$${\vert {E}_{RX} [ p ] + {E}_{LO} [ p ] \vert}^{2} = ( \overline{{E}_{RX} [ p ] - {E}_{LO} [ p ]} ) ( {E}_{RX} [ p ] + {E}_{LO} [ p ] ) = {P}_{TX} {\vert ( R X ) [ p ] \vert}^{2} + {P}_{LO} + ( \overline{{E}_{RX}} {E}_{LO} ) [ p ] + ( {E}_{RX} \overline{{E}_{LO}} ) [ p ] . \qquad ( Eq . S5 )$$

Expanding the second term in Eq. S4, similarly obtains

$${\vert {E}_{RX} [ p ] - {E}_{LO} [ p ] \vert}^{2} = {P}_{TX} {\vert ( RX ) [ p ] \vert}^{2} + {P}_{LO} - ( \overline{{E}_{RX}} - {E}_{LO} ) [ p ] - ( {E}_{RX} - \overline{{E}_{LO}} ) [ p ] . \qquad ( Eq . S6 )$$

Subtracting Eq. S6 from Eq. S5 gives

$$I [ p ] = 2 ( {E}_{RX} {E}_{LO} ) [ p ] + 2 ( {E}_{RX} {E}_{LO} ) [ p ] = 2 \sqrt{{P}_{TX}} \sqrt{{P}_{LO}} \vert ( R X ) [ p ] \vert ( {e}^{- j ( vt + ∠ ( R X ) [ p ] )} + {e}^{j ( vt + ∠ ( R X ) [ p ] )} ) = {\underbrace{4 \sqrt{{P}_{TX}} \sqrt{{P}_{LO}} \vert ( R X ) [ p ] \vert}}_{A [ p ]} cos ( vt + {\underbrace{∠ ( R X ) [ p ]}}_{ϕ [ p ]} ) . \qquad ( Eq . S7 )$$

According to the illustrative example, the balanced photodetectors 294a, 294b, generally 294, generally 294, remove virtually all steady-state signals. Any terms due to ambient light would also be canceled out in the balanced photodetection. A final photodetector current can be obtained as a cosine function whose amplitude can be the product of the transmit and receive amplitudes, the Jones matrix, and the transmitted symbol amplitudes. The frequency may depend on a Doppler shift, and the phase of the signal may depend on a phase of the Jones matrix entries and the transmitted symbols.

In at least some embodiments, the coherent modem captures complex-valued samples of the photocurrent. That is, the photocurrent signal is passed through a splitter, and one signal copy is sampled directly while the other copy is delayed by the phase shifter 293, e.g., with a 90 degree phase shift and then sampled. The resulting signal is

$${\underbrace{A [ p ] cos ( vt + ϕ [ p ] )}}_{in - phase} + {\underbrace{A [ p ] sin ( vt + ϕ [ p ] )}}_{quadrature} . \qquad ( Eq . S8 )$$

These two sampled signals are commonly called the in-phase and quadrature signal components, where the quadrature signal corresponds to the phase-delayed copy.

Finally, treating the in-phase and quadrature signals as the real and imaginary components of a complex-valued signal, respectively, yields

$$A [ p ] cos ( vt + ϕ [ p ] ) + j A [ p ] sin ( vt + ϕ [ p ] ) = A [ p ] {e}^{j ( vt + ϕ [ p ] )} ∝ {E}_{RX} [ p ] {e}^{- j ω t} . \qquad ( Eq . S9 )$$

such that the homodyne detection procedure recovers a complex-valued signal that is proportional to the received electric field. While noise in this derivation has been ignored for simplicity, it modeled using a complex Gaussian distribution. The dominating sources of noise are local oscillator shot noise and amplified spontaneous emission noise due to the Erbium-doped fiber amplifiers used to amplify the received laser light.

### Supplemental Implementation Details.

Optimization. In at least some embodiments, optimization can be implemented using a two-stage procedure. For example, first, it is noted that in the absence of total variation regularization the objective function (Eq. 13) can be minimized in a per-pixel fashion. For computational expediency, a first stage of optimization can be conducted, in which the values R_{Δ,ν} are estimated for each pixel in parallel using a sparsity regularizer. In at least some embodiments, the values R_{Δ,ν} are estimated for each pixel in parallel using only the sparsity regularizer. It can be assumed that in at least some scenarios, the maximum plausible distance from the system to be about 4 meters, and only optimized for the Jones matrices associated with the feasible time delays. It was observed that about 50 iterations of optimization using Adam with λₛₚₐᵣₛₑ=10-1 for static scenes and λₛₚₐᵣₛₑ=3×10-1 for dynamic scenes can be sufficient for the estimated depth to converge. To avoid unnecessary computation during the optimization, it can be assumed that R_{Δ,ν}=0 for all v #0 for scenes that are known to be static (i.e., no Doppler shift). In this case, optimization is only for the set of Jones matrices for which ν=0. For static pixels, this optimization may require a few seconds per pixel, e.g., using an NVIDIA A40 GPU. With an unoptimized implementation, it was found that processing each pixel with a Doppler shift requires roughly one minute on the same hardware.

In a second stage of optimization the total variation penalty can be added; this procedure requiring processing virtually the entire image at once due to dependencies between pixels. However, given the long sequence lengths of R_{Δ,ν} (typically several thousand samples along the temporal dimension), ETX (˜ 216 symbols), plus the additional dimensions associated with the number of pixels and the entries of the Jones matrix, it can be challenging to process the entire captured dataset at every iteration using full-batch gradient methods. Instead, a number of pixels and their neighbors can be stochastically sampled to calculate each term of Eq. 13, including the data term, the sparsity term, and the total variation penalty (a batch size of 1024 pixels was used at each iteration). It has been found that this stage of the optimization converges within about 500 iterations, for a total of about 550 iterations of optimization including the first stage. It has also been observed that the second stage of optimization takes roughly 30 minutes to complete using an Nvidia A40 GPU.

It is worth noting that a total variation penalty does not necessarily apply to dynamic scenes when estimating the Doppler shifts for the Jones matrices. While it was found that the total variation penalty can be effective for the static scenes (e.g., FIG. 9), the additional velocity dimension increases memory requirements, making it challenging to apply total variation to the large amount of data captured by the optical modem across all possible frequency shifts. Finding efficient ways to work with the large quantities of data captured by an optical modem is an interesting direction for future work.

Implementation of other modulation schemes. The FWL approach can be compared to using phase-only modulation with two polarization channels, amplitude-only modulation with two polarization channels, and phase and amplitude modulation with one polarization channel. The transmit power is kept the same as for FWL in all cases (including for the single polarization modulation scheme).

To implement the phase-only modulation scheme, a symbol sequence was generated with constant amplitude and uniformly distributed phases. Since according to the example embodiment, the intent was to emulate phase modulation-based lidars that are not sensitive to amplitude, the amplitude information was discarded by normalizing the symbols at the receiver prior to estimating depth or velocity. For amplitude-only modulation, symbols were transmitted with constant phase and normally distributed amplitudes. The reconstruction was performed by projecting the received symbols onto a complex-valued unit vector with the same phase used for modulation. This procedure removes the phase information from the receiver. Finally, for single-polarization phase and amplitude modulation, one of the polarization channels was simply discarded at the receiver.

Qualitative comparison of an example FWL system, such as any of the various embodiments disclosed herein, to a 3D depth camara system, e.g., the Azure Kinect® depth sensor. Kinect® is a registered trademark of the Microsoft Corp., Washington, and single-photon lidar. The example FWL system recovers accurate depth and velocity with only 1 μs exposure times per pixel and with an eye-safe 2 mW laser. The Kinect® depth sensor fails at light levels corresponding to 10 μs exposure times, which were emulated using neutral density filters. For the single-photon lidar system, a 10 μs exposure time was emulated by thinning the detected photon counts.

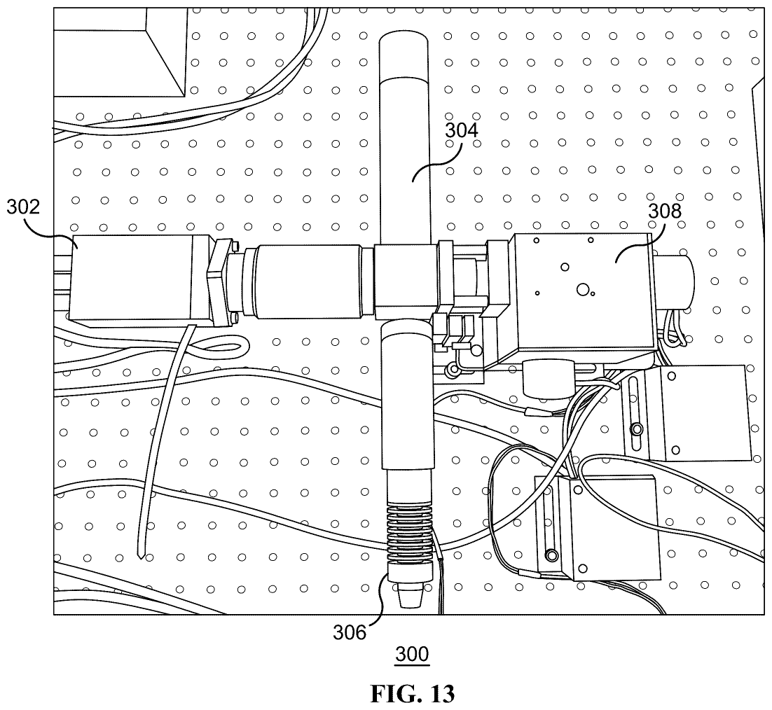

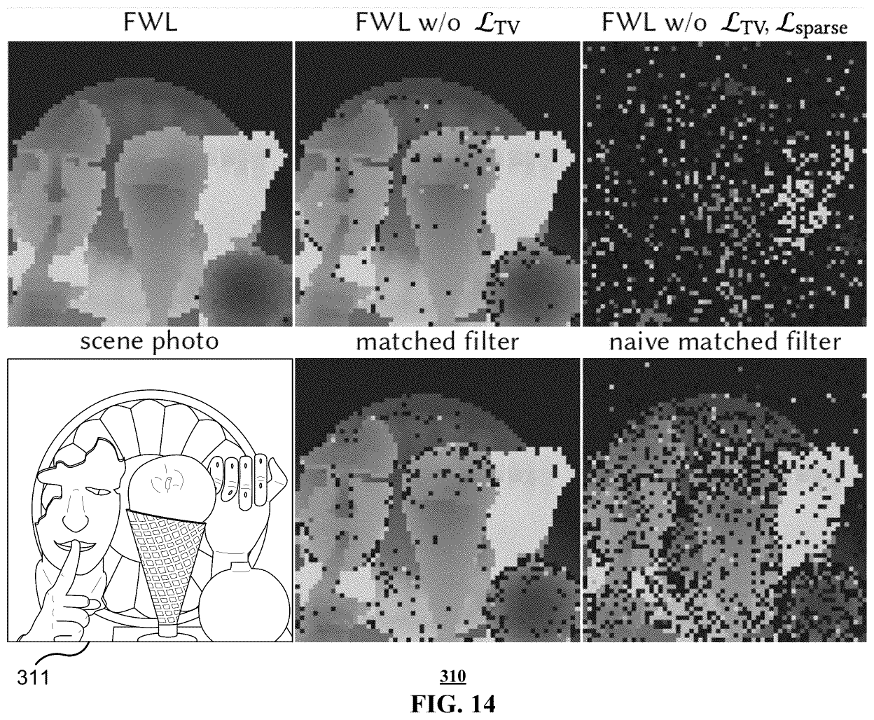

Single-photon lidar system. FIG. 13 is a photograph of an example, non-limiting embodiment of a single photon lidar system 300 in accordance with various aspects described herein. In particular, the example prototype, single-photon lidar system 300 was built to facilitate a comparison to FWL. The prototype, single-photon lidar system 300 includes a single-pixel single-photon avalanche diode 302 (SPAD; MPD Fast-Gated Module), a beam splitter 304 to separate the outgoing laser beam and incoming reflected light, a picosecond pulsed laser 306 operating at 670 nm (Alphalas Picopower), a pair of scanning mirrors 308 (Thorlabs GVS012), and a time-correlated single photon counter (TCSPS; PicoQuant PicoHarp 300). The laser pulse repetition rate was set to 10 MHz and the power was configured to achieve approximately 500,000 photon counts per second, which is roughly the threshold at which non-linear pileup effects are still negligible.

### Supplemental Results.

Supplemental ablation studies. Additional results are provided herein showing the performance of FWL with both total variation and sparsity regularization, without total variation regularization, and without any regularization. FIG. 14 illustrates graphical results 310 obtained for a sample image using the various approaches disclosed herein, in accordance with the various aspects disclosed herein. In particular, the graphical results 310 illustrate performance of FWL regularization and matched filtering. The graphical results 310 suggest that FWL obtained using both total variation and sparsity regularizers (top left) perform best for the example scene 311 containing a few static objects. The graphical results 310 further suggest that the approach without total variation (top middle) is more sensitive to speckle noise, and removing both regularizers results in poor performance. The graphical results 310 further suggest that the generalized matched filter (bottom middle) performs better than “naive” matched filtering (bottom right), which uses cross correlations between the two corresponding polarization channels and fails to exploit cross-polarization information. It was determined that using both regularizers produces the best results for this example static scene 311. The performance of generalized matched filtering was also compared, which correlates the known transmit sequence at each polarization channel with each of the received polarization channels (i.e., exploits cross-channel polarization information). It was determined that this approach recovers depth estimates with fewer outliers than a naive form of matched filtering, which only correlates the corresponding transmit and receive polarization channels.

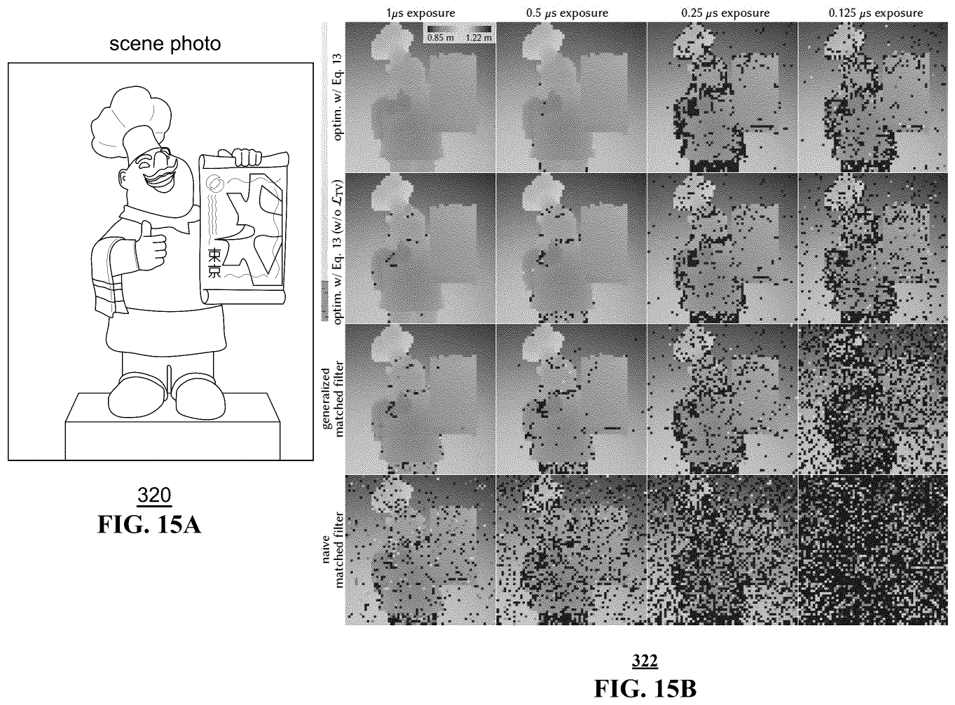

Similar trends were observed in FIG. 15B, which illustrates graphical results 322 obtained for a sample image 320 presented in FIG. 15A, using the various approaches disclosed herein, in accordance with the various aspects disclosed herein. The graphical results 322 show the same comparison for a range of exposure times. The graphical results 322 provide additional comparisons of FWL and matched filtering vs. exposure time. In particular, reconstructions were compared using both sparsity and total variation regularization (row 1) to the optimization without total variation regularization (row 2). Reconstructions were also compared to generalized matched filtering (row 3), which exploits cross polarization information, and naive matched filtering (row 4), which correlates the two corresponding polarization channels. According to the graphical results 322, FWL using both regularizers produces depth maps with the fewest outliers as the exposure time decreases. As the exposure time decreases, the graphical results 322 indicate that FWL using both sparsity and total variation regularization produces depth maps with the fewest outliers compared to matched filtering or FWL without sparsity or total variation regularization.

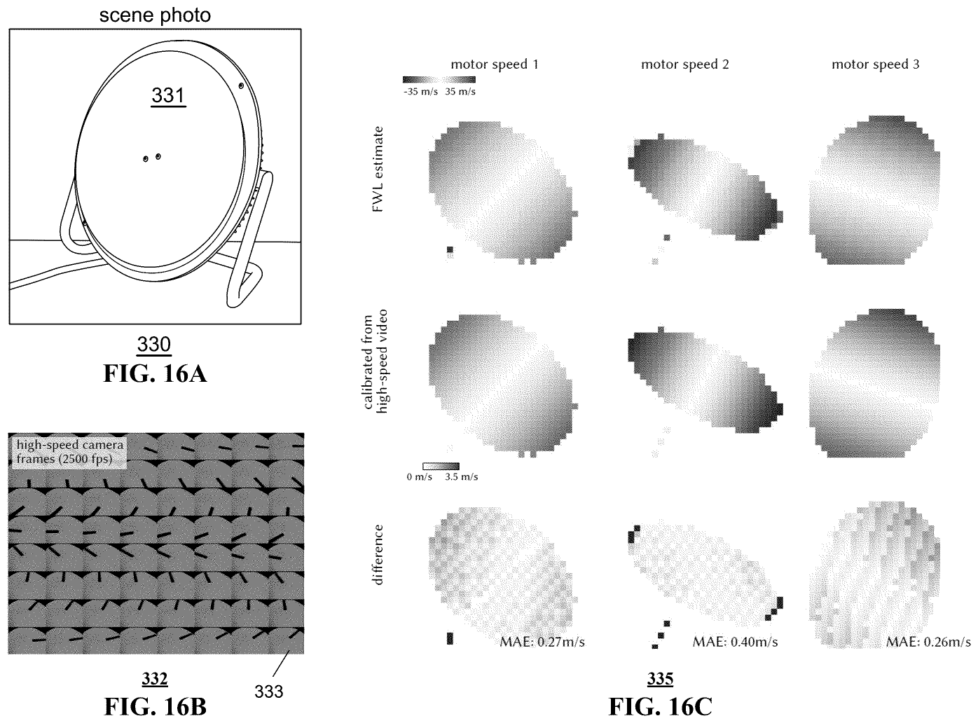

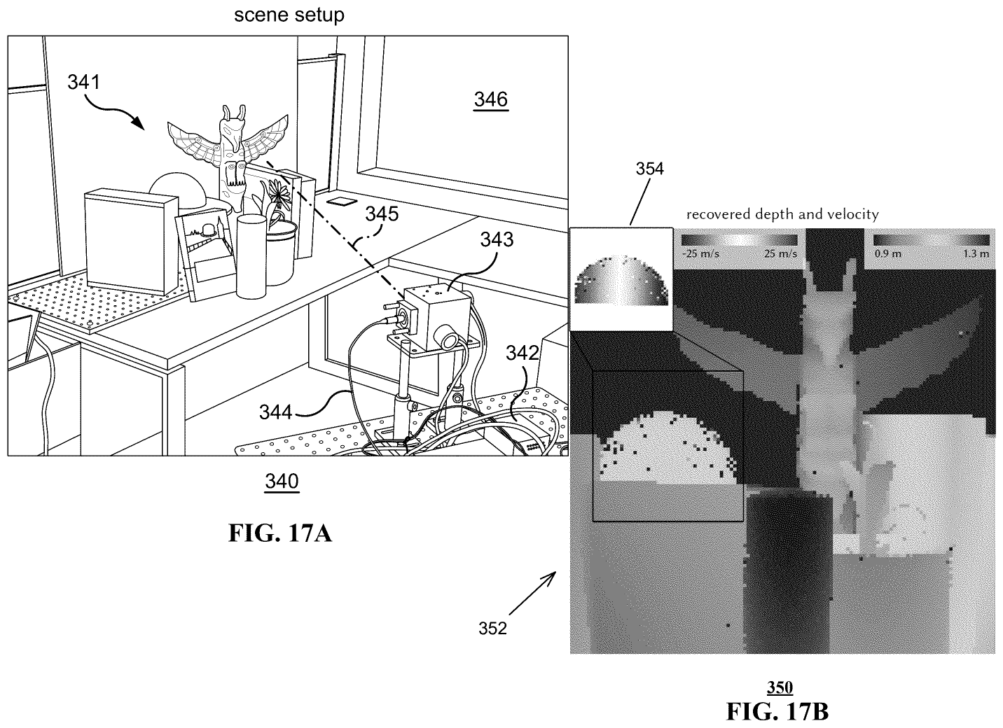

FIG. 16A is a photograph illustrating an experimental setup 330 for assessing radial velocity predictions obtained from a coherent optical modem for a rotating disk 331 in accordance with various aspects described herein.

FIG. 16B is a series of high-speed photographs 332 illustrating rotation of the rotating disk 331 of the experimental setup 330 depicted in FIG. 16A in accordance with various aspects described herein. A high-speed camera was used to capture frames 333 of the spinning disk 331 after adding a marker to track its position.

FIG. 16C is a graphical diagram illustrating an example, non-limiting embodiment of experimental results 335 for assessing radial velocity predictions for the rotating disk of the experimental setup of FIGS. 16A and 16B using a coherent optical modem in accordance with various aspects described herein. A transmit power of 10 mW was used for this experiment. According to the illustrative example experiment, depth estimates of the spinning disk 331 were obtained from the coherent optical modem. A plane was then fit to the depth estimates and the rotational speed from the high-speed camera was used to estimate the radial velocity of the disk. The graphical results 335 include radial velocities computed in this fashion (second row) and using the Doppler shift from the optical modem (top row) for three different rotating disk orientations and motor speeds (columns 1-3). It was found in this instance, that the estimates from both methods agree to within a meter per second in terms of mean absolute error (MAE) (bottom row).

FIG. 17A is a photograph illustrating an experimental setup 340 for assessing performance of a coherent optical modem 342 evaluating a scene 341 in accordance with various aspects described herein. The experimental setup 340 includes the coherent modem 342, a scanning mirror assembly 343 and a fiber optical cable 344 coupled between the coherent optical modem 342 and the scanning mirror assembly 343. An optical signal from a transmitter of the coherent optical modem 342 is directed by scanning mirrors of the scanning mirror assembly 343 to generate a scanning beam 345 that illuminates the scene 341 according to a scanning pattern, e.g., a rasterized scanning pattern. According to the illustrative example, the scene 341 is illuminated with natural sunlight 346 through an adjacent window.

FIG. 17B is a graphical diagram illustrating an example, non-limiting embodiment of experimental results 350 for assessing performance of a coherent optical modem in evaluating the scene depicted in FIG. 17A accordance with various aspects described herein. The example experimental results 350 are in the form of reproduced depth reconstructions 352 and velocity reconstructions 354.

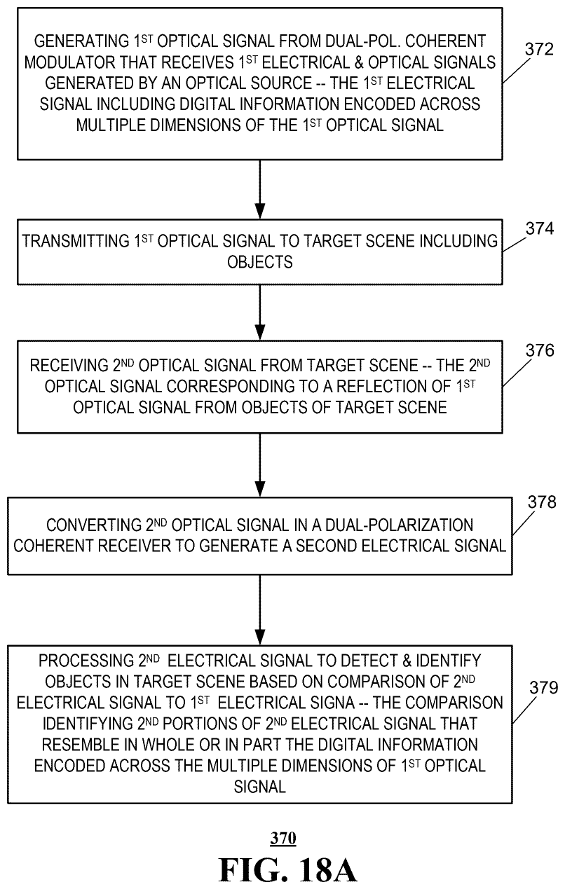

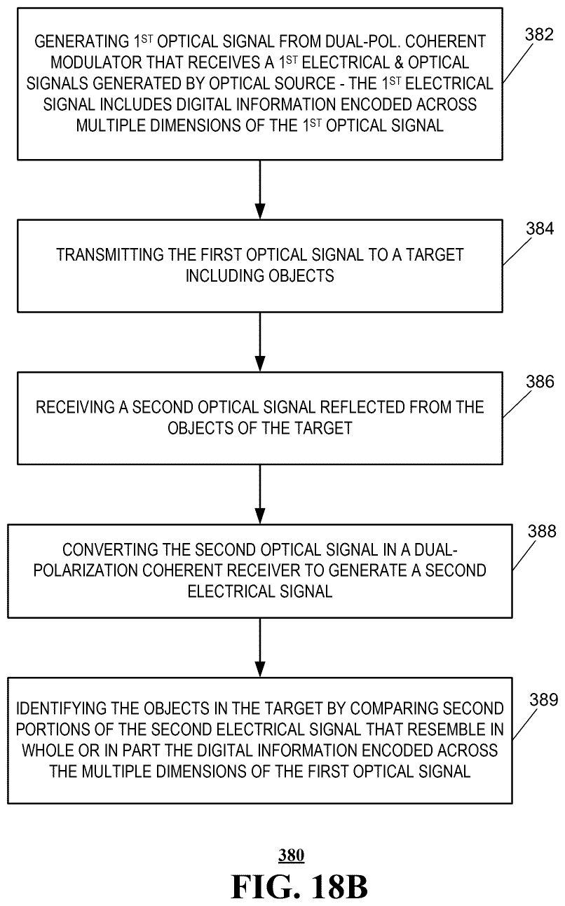

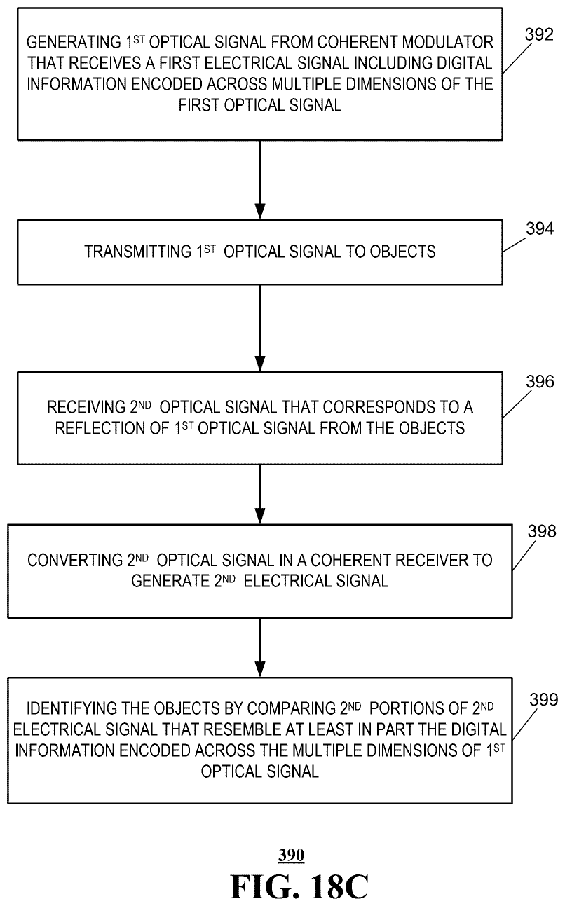

FIG. 18A depicts an illustrative embodiment of a process 370 for analyzing objects using a coherent optical system, in accordance with various aspects described herein. The example process 370 begins with step 372, in which a first optical signal is generated from a dual-polarization coherent modulator. In at least some embodiments, this modulator receives a first electrical signal and optical signals generated by an optical source, with the first electrical signal containing digital information encoded across multiple dimensions of the first optical signal. In step 374, the first optical signal is transmitted to a target scene that includes objects. Step 376 involves receiving a second optical signal from the target scene, which corresponds to a reflection and/or backscatter of the first optical signal from the objects. In step 378, the second optical signal can be converted in a dual-polarization coherent receiver to generate a second electrical signal. Finally, step 379 involves processing the second electrical signal to detect and identify objects in the target scene by comparing the second electrical signal to the first electrical signal, identifying portions of the second electrical signal that resemble, in whole or in part, the digital information encoded across the multiple dimensions of the first optical signal.

FIG. 18B depicts an illustrative embodiment of another process 380 for analyzing objects using a coherent optical system, in accordance with various aspects described herein. The example process begins with step 382, which involves generating a first optical signal from a dual-polarization coherent modulator. This modulator receives a first electrical signal and optical signals generated by an optical source, where the first electrical signal includes digital information encoded across multiple dimensions of the first optical signal. In step 384, the first optical signal is transmitted to a target that includes objects. Step 386 involves receiving a second optical signal reflected from the objects of the target. In step 388, the second optical signal is converted in a dual-polarization coherent receiver to generate a second electrical signal. Finally, step 389 involves identifying the objects in the target by comparing second portions of the second electrical signal that resemble, in whole or in part, the digital information encoded across the multiple dimensions of the first optical signal.

FIG. 18C depicts an illustrative embodiment of yet another process 390 for analyzing objects using a coherent optical system, in accordance with various aspects described herein. The process begins with step 392, where a first optical signal is generated from a coherent modulator that receives a first electrical signal, which includes digital information encoded across multiple dimensions of the first optical signal. In step 394, the first optical signal is transmitted to objects in the target scene. Step 396 involves receiving a second optical signal that corresponds to a reflection of the first optical signal from the objects. In step 398, the second optical signal is converted in a coherent receiver to generate a second electrical signal. Finally, step 399 involves identifying the objects by comparing second portions of the second electrical signal that resemble, at least in part, the digital information encoded across the multiple dimensions of the first optical signal.

While for purposes of simplicity of explanation, the respective processes are shown and described as a series of blocks in FIGS. 18A through 18C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

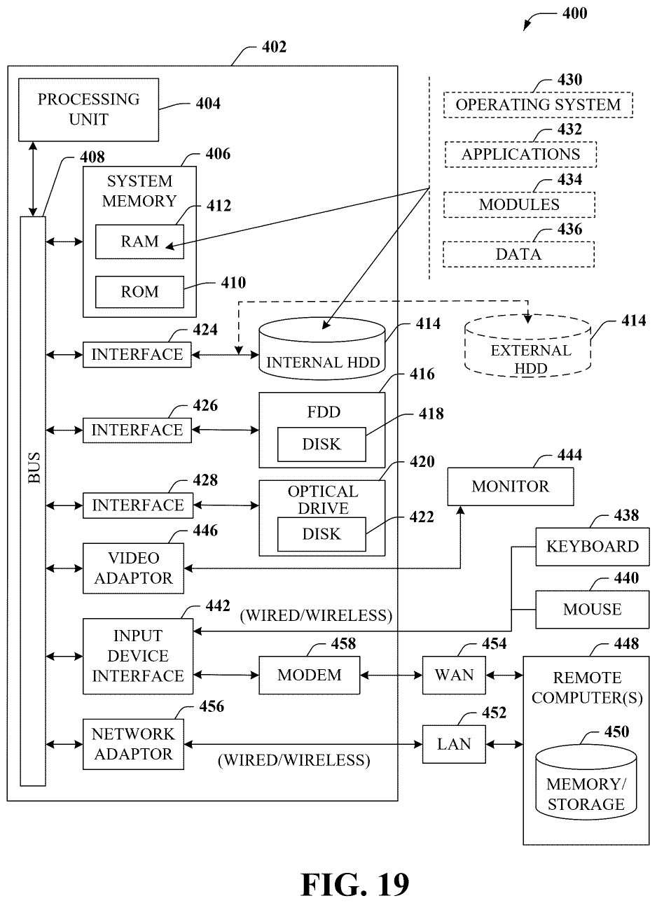

Turning now to FIG. 19, there is illustrated a block diagram of a computing environment in accordance with various aspects described herein. In order to provide additional context for various embodiments of the embodiments described herein, FIG. 19 and the following discussion are intended to provide a brief, general description of a suitable computing environment 400 in which the various embodiments of the subject disclosure can be implemented. For example, computing environment 400 can facilitate in whole or in part analyzing objects using a coherent optical system, e.g., by utilizing multi-polarization, e.g., at least dual-polarization, coherent modulation to generate optical signals that can be encoded with digital information across multiple dimensions, such as one or more of an amplitude, phase, and/or polarization. These signals can be transmitted to a target scene resulting in reflected and/or backscattered signals that can be received and processed to detect and identify objects based on a comparison with the original transmitted signals. Detection can include depth information, e.g., distance from a reference plane, such as a plane containing the optical source. In at least some embodiment, detection can include identifying object shapes. Alternatively, or in addition, detection can include identifying moving objects, e.g., including one or more of a speed and/or direction or velocity of the moving object, a shape and/or orientation of the moving object and/or a depth and/or distance of the moving object from a reference location.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 19, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples provided with an understanding that other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
generating a first optical signal from a dual-polarization coherent modulator, wherein the dual-polarization coherent modulator receives a first electrical signal and optical signals generated by an optical source, wherein the first electrical signal includes digital information encoded across multiple dimensions of the first optical signal;
transmitting the first optical signal to a target scene including objects;
receiving a second optical signal from the target scene, wherein the second optical signal corresponds to a reflection of the first optical signal from the objects of the target scene;
converting the second optical signal in a dual-polarization coherent receiver to generate a second electrical signal; and
processing the second electrical signal to detect and identify the objects in the target scene based on a comparison of the second electrical signal to the first electrical signal, the comparison identifies second portions of the second electrical signal that resemble in whole or in part the digital information encoded across the multiple dimensions of the first optical signal.

2. The method of claim 1, wherein the objects in the target scene are characterized by variables utilized in the comparison, the variables include distance, relative velocity, intensity, polarization, orientation, or combinations thereof.

3. The method of claim 2, wherein the processing of the second electrical signal characterizes the variables singly or in any combination.

4. The method of claim 1, wherein the optical source comprises one or more narrow-linewidth continuous-wave lasers.

5. The method of claim 1, wherein the multiple dimensions of the first optical signal include amplitude, phase, polarization, or any combination thereof, and wherein the digital information encoded across the multiple dimensions of the first optical signal is mutually correlated or uncorrelated.

6. The method of claim 1, wherein the digital information encoded across multiple dimensions of the first optical signal includes pseudo-random data selected from a class of orthogonal sequences.

7. The method of claim 1, wherein the second optical signal is received via a lens that is used for transmitting the first optical signal.

8. The method of claim 1, wherein the second optical signal is received via a first lens that differs from a second lens used for transmitting the first optical signal.

9. The method of claim 1, wherein the second optical signal is related to the first optical signal via reflection, refraction, diffusion, scattering, or combinations thereof.

10. The method of claim 1, wherein the processing the second electrical signal is performed by a cross-correlation of the second portions of the second electrical signal with first portions of the first electrical signal.

11. The method of claim 1, wherein the second portions of the second electrical signal are identified based on a second phase of the second optical signal, a second amplitude of the second optical signal, a second polarization of the second optical signal, or combinations thereof compared to a first phase of the first optical signal, a first amplitude of the first optical signal, a first polarization of the first optical signal, or combinations thereof.

12. The method of claim 1, wherein the comparison of the second electrical signal to the first electrical signal is based on a model of the second optical signal that includes phase, amplitude, polarization, or combinations thereof, and wherein variables of the model include time, velocity, position, orientation, or combinations thereof.

13. The method of claim 12, wherein the comparison of the second electrical signal to the first electrical signal is performed using a gradient descent algorithm.

14. The method of claim 12, wherein the comparison of the second electrical signal to the first electrical signal limits a search space of the variables to increase efficiency of the comparison.

15. The method of claim 12, wherein the comparison of the second electrical signal to the first electrical signal is performed via time gating, polarization gating, angular gating, doppler gating, or combinations thereof.

16. The method of claim 12, wherein the comparison of the second electrical signal to the first electrical signal utilizes sparsity of the target scene to detect or identify the objects.

17. The method of claim 16, wherein the comparison of the second electrical signal to the first electrical signal utilizes regularizers, and wherein the regularizers include L1 norm, Frobenius norm, determinant, unitary constraints, or combinations thereof of the model of the second optical signal, and wherein the regularizers are related to a signal-to-noise ratio of the second electrical signal, and wherein the regularizers are applied to a portion of the second electrical signal, and wherein the regularizers are chosen to be robust to noise.

18. A device, comprising:
a processing system including a processor; and
a memory that stores executable instructions that, when executed by the processing system, facilitate performance of operations, the operations comprising:
generating a first optical signal from a dual-polarization coherent modulator, wherein the dual-polarization coherent modulator receives a first electrical signal and optical signals generated by an optical source, wherein the first electrical signal includes digital information encoded across multiple dimensions of the first optical signal;
transmitting the first optical signal to a target including objects;
receiving a second optical signal reflected from the objects of the target;
converting the second optical signal in a dual-polarization coherent receiver to generate a second electrical signal; and
identifying the objects in the target by comparing second portions of the second electrical signal that resemble in whole or in part the digital information encoded across the multiple dimensions of the first optical signal.

19. A non-transitory, machine-readable medium, comprising executable instructions that, when executed by a processing system including a processor, facilitate performance of operations, the operations comprising:
generating a first optical signal from a coherent modulator, wherein the coherent modulator receives a first electrical signal that includes digital information encoded across multiple dimensions of the first optical signal;
transmitting the first optical signal to objects;
receiving a second optical signal that corresponds to a reflection of the first optical signal from the objects;
converting the second optical signal in a coherent receiver to generate a second electrical signal; and
identifying the objects by comparing second portions of the second electrical signal that resemble at least in part the digital information encoded across the multiple dimensions of the first optical signal.

20. The non-transitory, machine-readable medium of claim 19, wherein the coherent modulator corresponds to a dual-polarization coherent modulator, and wherein the coherent receiver corresponds to a dual-polarization coherent receiver.
